(19) United States
(12) Patent Application Publication
(10) Pub. No.: US 2026/0064384 A1
(43) Pub. Date: Mar. 5, 2026

(54) CONTEXT-AWARE CODE GENERATION AND MODIFICATION

(71) Applicant: For Good AI Inc., Campbell, CA (US)

(72) Inventors: Andrey Filev, Campbell, CA (US); Dmitrii Krasnov, Belgrade (RS)

(21) Appl. No.: 19/309,855

(22) Filed: Aug. 26, 2025

Related U.S. Application Data
(60) Provisional application No. 63/690,246, filed on Sep. 3, 2024.
(60) Provisional application No. 63/699,595, filed on Sep. 26, 2024.

(51) Int. Cl. G06F 8/35; G06F 8/75

(52) U.S. Cl. CPC G06F 8/35; G06F 8/75

(57) ABSTRACT

A system and method for generating computer code are provided. The system receives data indicating a trigger event to initiate code generation and selects a code generation agent based on attributes of the trigger event. The selected agent requests indexed context information from a context indexing component. The context indexing component generates indexed context information including project data associated with a user account, such as existing code, text data, file structure data, open file information, and project documentation. First embeddings are generated from the processed project data and stored in a vector database configured to be queried by the code generation agent. The system can further generate environmental data, hierarchical file structure summarizations, and indexed external data, creating additional embeddings stored in the vector database to provide comprehensive context for code generation.

### RELATED APPLICATIONS

This application claims priority U.S. Provisional Patent Application No. 63/690,246, filed Sep. 3, 2024, and U.S. Provisional Patent Application No. 63/699,595, filed Sep. 26, 2024, the entire contents of which are incorporated herein by reference.

### BACKGROUND

Software development is a complex and time-consuming process that often involves multiple stages, from initial code generation to debugging and maintenance. As codebases grow in size and complexity, developers face increasing challenges in efficiently creating, understanding, and modifying code. Traditional integrated development environments (IDEs) and coding tools, while useful, often lack the contextual awareness and intelligent assistance needed to significantly boost developer productivity. One major challenge in software development is the difficulty of generating high-quality, consistent code that adheres to project-specific standards and best practices. Developers must often manually search through extensive documentation, existing codebase, and external resources to find relevant information and examples. This process is time-consuming and prone to errors, leading to inconsistencies and potential bugs in the final product. Another significant issue is the detection and correction of code errors. While existing tools can identify certain types of errors, they often struggle with more complex, context-dependent issues. Furthermore, the process of fixing these errors typically requires manual intervention, which can be tedious and error-prone, especially for large codebases or when dealing with unfamiliar code.

The creation and maintenance of graphical user interfaces (GUIs) present additional challenges. Developers must ensure consistency across different components and screens while also adhering to design guidelines and accessibility standards. This process often involves significant back-and-forth between designers and developers, leading to inefficiencies and potential miscommunications.

Existing solutions for code generation and error correction often lack the flexibility to adapt to specific project requirements or user preferences. They may also struggle to integrate seamlessly with existing development workflows and tools, limiting their practical utility in real-world scenarios. As software projects continue to grow in scale and complexity, there is a clear need for more intelligent, context-aware tools that can assist developers throughout the entire development process, from initial code generation to ongoing maintenance and optimization.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment for code generation and bug fixing, including a code generation platform and user devices, in accordance with examples of the disclosure.

FIG. 2 illustrates an example flow diagram of a process for generating and processing code using a code generation platform, according to aspects of the present disclosure.

FIG. 3 illustrates an example flow diagram of process performed by a context indexer to process user queries and generate relevant responses, in accordance with examples of the disclosure.

FIG. 4A illustrates an example flow diagram of an external data indexing sub-process for structuring and indexing various types of external data, according to an embodiment.

FIG. 4B illustrates an example flow diagram of a user data indexing sub-process for structuring and indexing various types of user data, in accordance with examples of the disclosure.

FIG. 4C illustrates an example flow diagram of a company data indexing sub-process for structuring and indexing various types of company data, according to aspects of the present disclosure.

FIG. 4D illustrates an example flow diagram of a first retrieval step sub-process for gathering relevant information from various data sources, in accordance with examples of the disclosure.

FIG. 4E illustrates an example flow diagram of a second retrieval step sub-process for filtering and processing retrieved data, according to an embodiment.

FIG. 5 illustrates an example flow diagram for calling an agent in a code generation platform, in accordance with examples of the disclosure.

FIG. 6 illustrates an example flow diagram of a process performed by a code repair tool to generate and apply code patches, according to aspects of the present disclosure.

FIG. 7 illustrates an example flow diagram of a process for creating and configuring a new agent using a code generation platform, in accordance with examples of the disclosure.

FIG. 8 illustrates an example flow diagram of a process for generating and utilizing machine learning models, according to an embodiment.

FIG. 9 illustrates an example flow diagram of a process for generating computer code using context indexing and embeddings, in accordance with examples of the disclosure.

FIG. 10 illustrates another example flow diagram of a process for generating computer code using context indexing and embeddings, according to aspects of the present disclosure.

FIG. 11 illustrates an example flow diagram of a process for generating computer code using a context indexing component, in accordance with examples of the disclosure.

FIG. 12 illustrates an example flow diagram of a process for retrieving and filtering data for computer code generation, in accordance with examples of the disclosure.

FIG. 13 illustrates an example flow diagram of a process for generating and filtering context information for computer code generation, in accordance with examples of the disclosure.

FIG. 14 illustrates an example flow diagram of a process for generating computer code using a code generation component, in accordance with examples of the disclosure.

FIG. 15 illustrates an example flow diagram of a process for generating patched computer code, in accordance with examples of the disclosure.

FIG. 16 illustrates an example flow diagram of a process for generating patched computer code using multiple feedback mechanisms, in accordance with examples of the disclosure.

FIG. 17 illustrates an example flow diagram of a process for generating and storing a custom computer code generation agent, in accordance with examples of the disclosure.

FIG. 18 illustrates another example flow diagram of a process for generating and storing a custom computer code generation agent, in accordance with examples of the disclosure.

FIG. 19 illustrates an example flow diagram of a process for generating computer code associated with elements of a graphical user interface, in accordance with examples of the disclosure.

FIG. 20 illustrates an example flow diagram of a process for generating code completion recommendations, in accordance with examples of the disclosure.

FIG. 21 illustrates an example flow diagram of a process for generating and verifying unit tests for existing code, in accordance with examples of the disclosure.

FIG. 22 illustrates an example flow diagram for generating a unit testing agent in a code generation platform, in accordance with examples of the disclosure.

### DETAILED DESCRIPTION

Traditional software development processes may face challenges in efficiently generating high-quality, consistent code that adheres to project-specific standards and best practices. Additionally, existing tools for code generation and error correction may lack the contextual awareness and flexibility needed to seamlessly integrate with diverse development workflows, potentially leading to inefficiencies and inconsistencies in the final product. This application relates to a system and techniques for generating and modifying computer code using a context-aware approach and multi-agent architecture. The system (also referred to herein as the platform or the code generation platform) may employ a context indexing component to gather and process relevant project data, a code generation agent to produce or patch code based on the indexed context, and a large language model to identify and correct errors. The platform may create custom code generation agents with user-defined triggers and actions, generate graphical user interface (GUI) code with specific properties, and integrate existing components into new code. By leveraging context understanding and error correction capabilities, the system may improve code quality, reduce development time, and enhance collaboration between designers and developers.

The code generation platform described represents a system designed to enhance computer code generation and modification processes. The platform may leverage a context-aware approach, utilizing a multi-agent architecture and technologies to potentially enhance developer productivity and code quality across diverse software development scenarios. The platform's foundation may be built upon its ability to gather, process, and utilize a range of contextual information. This context-aware methodology may enable the generation of relevant code, tailored to the specific needs of individual users and projects. The context indexing component may serve as an component, collecting and organizing various types of project-related data, including existing code repositories, documentation, file structures, and environmental information.

To manage and store this indexed context information, the platform may employ a database system. By utilizing vector databases and embedding techniques, contextual data may be represented in a format that facilitates retrieval. This approach may allow a code generation agent to swiftly access relevant information when creating or modifying code, potentially resulting in more accurate and contextually appropriate code generation.

The platform's multi-agent architecture may provide flexibility and specialization in code generation tasks. Each agent within the platform may be designed to excel in specific types of code generation or to work with particular programming languages or frameworks. This modular approach may allow the platform to address a range of coding scenarios, from creating entirely new code bases to patching and optimizing existing codebases. To further enhance its capabilities, the platform may integrate large language models (LLMs). These artificial intelligence (AI) models may enable understanding of context and generation of code. LLMs may assist in various aspects of the code generation process, including interpreting user requirements, generating code snippets, and providing explanations or documentation for the generated code. This integration may elevate the platform's ability to understand coding requirements and produce contextually relevant code.

The platform's trigger system may play a role in initiating and managing code generation tasks. It may respond to various types of events, such as explicit user queries, predefined project milestones, or detected code issues. Working in conjunction with the agent selector, the trigger system may determine the response to each event, ensuring that an appropriate code generation agent is deployed for each specific task. For handling complex code generation tasks, the platform may employ a multistep agent flow. This may allow for a series of code generation steps, potentially involving multiple agents, to address more complex or multi-faceted coding requirements. This approach may enable the platform to break down complex tasks into manageable components, each handled by a suitable agent.

The platform may also offer capabilities for code repair and optimization. By analyzing existing code, identifying errors or potential improvements, and generating patches or suggestions, the platform may enhance code quality and performance. This process may involve multiple steps, including diagnostics, generating potential fixes, and applying patches in a controlled manner. In projects involving graphical user interfaces (GUIs), the platform may provide capabilities for generating code associated with GUI elements. These capabilities may take into account factors such as design specifications, user interaction patterns, and platform-specific UI guidelines, aiming to ensure that the generated GUI code is both functional and aligned with best practices in user interface design.

The platform's flexibility may extend to its ability to work with various programming languages and frameworks. By maintaining language-specific knowledge bases and adapting its code generation strategies based on the target language or framework, the platform may provide assistance across a range of development environments. Collaboration features may be incorporated into the platform, allowing multiple developers to benefit from shared context and code generation resources. This may include features for sharing custom agents, collaborative code review of generated code, and integration with version control systems, potentially fostering a more efficient and cohesive development process within teams. The platform may also offer capabilities for simultaneous code documentation and explanation. It may produce comments, inline documentation, or separate documentation files to explain the logic and functionality of the generated code, potentially improving code readability and maintainability.

Performance optimization may be another area where the platform provides value. By suggesting or implementing optimizations to improve code efficiency, reduce resource usage, or enhance scalability based on the analysis of context and requirements, the platform may contribute to the overall performance and efficiency of the developed software. The architecture of the platform may be designed to be scalable and extensible, supporting cloud-based deployment for handling large-scale code generation tasks across multiple projects or organizations. Its modular design may allow for the addition of new features, agents, or integrations as needed, ensuring that the platform can evolve to meet changing development needs and incorporate new technologies as they emerge.

In summary, the code generation platform disclosed herein represents a solution for context-aware code generation and modification. Its multi-agent architecture, context indexing, processing capabilities, and customization options may make it a tool for enhancing developer productivity and code quality across a range of software development scenarios. By leveraging technologies and understanding of development contexts, this platform may streamline and improve the software development process.

In some examples, a system for generating computer code may include one or more processors and non-transitory computer-readable media storing computer-executable instructions. When executed, these instructions may cause the system to perform operations including receiving first data indicating a trigger event for initiating generation of computer code in a code generation session. The system may select a code generation agent based on attributes of the trigger event to generate the computer code. The selected agent may request a context indexing component to provide indexed context information associated with the code generation session.

In some examples, the context indexing component may generate the indexed context information to include project data associated with the code generation session. This project data may comprise existing computer code, text data, file structure data, open file information, and/or project documentation associated with a user account. The indexed context information may be stored in a database that can be queried by the code generation agent to generate the computer code. The system may then generate the computer code based on the selected code generation agent and the context indexing component processing the project data. Additionally, or alternatively, the system may generate first embeddings from the project data as processed by the context indexing component and store these embeddings in a vector database. The vector database may be configured to be queried by the code generation agent to generate the computer code. In some examples, the system may also generate environmental data associated with the code generation session, including library information, operating system details, and database information utilized by the user account. Second embeddings may be generated from this environmental data and stored in the vector database.

In some examples, the system may identify files associated with the user account and determine a file structure from the file structure data. A hierarchical summarization of the file structure may be generated, with second embeddings created from this summarization and stored in the vector database. Additionally, or alternatively, the system may request indexed external data, including plugin documentation, external documents, language and framework specifications, security vulnerability information, and related public documents. Embeddings generated from this indexed external data may be stored in the vector database, indicating differences between the indexed external data and the indexed context information. In some examples, the system may receive a query for a computer code generation component to initiate generation of computer code. The system may determine attributes of the query and use these to determine subsets of embeddings generated from indexed external data, indexed context information, and indexed company data. These subsets of embeddings may be associated with various types of information, such as plugin documentation, existing computer code, and company documents. The system may query a vector database storing these embeddings and receive text portions and file paths associated with the subsets of embeddings. Additionally, or alternatively, the system may filter the retrieved data using a large language model (LLM). The LLM may filter text portions, files associated with indexed context information, and files associated with indexed company data to generate filtered results data. This filtered results data may include filtered external data, filtered context files, and filtered company data. In some examples, the system may rank or rerank the filtered results data using the LLM, potentially merging the data into a unified dataset based on this ranking.

In some examples, the system may be configured to generate patched computer code. It may receive a query to initiate generation of patched code, select a code generation agent, and determine previous computer code generated in a previous session (e.g., as indicated by a target file). The system may leverage a diagnostics component to generate diagnostics data indicative of errors in the previous code, filter these errors to produce filtered diagnostics data indicating error types, and use an LLM to generate hunks indicative of the errors. These hunks may be organized based on the error types indicated by the filtered diagnostics data. The system may then patch the previous computer code using these hunks to generate the patched computer code. Additionally, or alternatively, the system may generate first feedback data indicative of first errors using the diagnostics component and second feedback data indicative of second errors using analytical tools associated with the system. These first and second errors may be merged to create merged feedback data, which may be used by an LLM to generate hunks indicative of the merged errors. The system may then patch the previous computer code using these hunks.

In some examples, the system may generate a user interface for creating custom computer code generation agents. This interface may include elements for selecting agent types, trigger events, and actions. The system may receive selections for these elements, generate a script representing the custom agent based on these selections, and store the custom agent in a library associated with a user profile. The custom agent may later be selected and used to generate computer code when its associated trigger event occurs. Additionally, or alternatively, the system may be configured to generate computer code associated with elements of a graphical user interface (GUI). It may select a GUI code generation agent based on trigger event attributes, request indexed context information, and generate the code based on this information. The system may determine properties associated with the GUI, such as elements to be included, their appearance, functionality, organization, associated errors, or overall design. These properties may be used in generating the computer code for the GUI elements.

As described above, the system may include a context indexing component. In some examples, the context indexing component may be configured as a software module or system component responsible for gathering, processing, and organizing relevant contextual information associated with a computer code generation session. The context indexing component may analyze various data sources, including existing computer code, text data, file structures, open files, and project documentation associated with a user account. It may also process environmental data such as installed libraries, operating system details, and database information. The context indexing component may generate indexed context information, which can be stored in a database and queried by code generation agents to enhance the relevance and accuracy of generated code. In some examples, the context indexing component may create embeddings or vector representations of the processed data, enabling efficient retrieval and utilization of context during code generation tasks.

Additionally, or alternatively, as described above, the system may include one or more code generation agent(s). In some examples, a code generation agent may be configured as a software entity designed to generate computer code for specific purposes within a code generation platform. Code generation agents may be selected based on attributes of a trigger event or query, and may be configured to produce code tailored to particular tasks or domains. These agents may interact with the context indexing component to retrieve relevant information and may utilize large language models (LLMs) or other AI techniques to generate, modify, or repair code. Code generation agents may be specialized for various purposes, such as creating original code, patching existing code, or generating code for graphical user interfaces (GUIs). In some examples, custom code generation agents may be created by users, allowing for specialized and personalized code generation capabilities.

Additionally, or alternatively, as described above, the system may react to one or more trigger event(s). In some examples, a trigger event may comprise an occurrence or condition that initiates the process of computer code generation within the system. Trigger events may take various forms, such as user queries, predefined project milestones, detected code issues, or specific actions within an integrated development environment (IDE). The attributes of a trigger event may be used to select appropriate code generation agents and determine the context and requirements for the code generation task. Trigger events may be associated with different types of code generation tasks, such as creating new code, repairing existing code, or generating GUI elements. The system's ability to respond to diverse trigger events may enable it to provide timely and relevant assistance throughout the software development lifecycle.

Additionally, or alternatively, as described above, the system may include graphical user interface (GUI) code generation agents. The process of automatically creating computer code that defines and implements elements of a graphical user interface. GUI code generation may involve selecting a specialized GUI code generation agent based on trigger event attributes and utilizing indexed context information to produce relevant and consistent interface code. The system may determine various properties associated with the GUI, including the elements to be included, their appearance, functionality, organization, potential errors, and overall design. These properties may guide the code generation process, aiming to ensure that the resulting GUI code aligns with project requirements and design standards. GUI code generation may streamline the development of user interfaces, potentially reducing the time and effort required to create visually appealing and functional application front-ends.

Additionally, or alternatively, as described above, the system may generate patched computer code. In some examples, patch computer code may represent the result of a code repair or modification process where errors or issues in existing code are identified and corrected. Patched computer code may be generated by specialized code generation agents that analyze previous code, identify errors, and apply corrections or improvements. The patching process may involve generating “hunks,” which are sections of code indicating specific changes to be made. These hunks may then be used to modify the original code, inserting, deleting, or altering portions as needed. Patched computer code may aim to improve the functionality, performance, or security of the original code while maintaining its overall structure and purpose. The patching process may utilize large language models and context information to ensure that the applied changes are appropriate and consistent with the broader codebase.

Additionally, or alternatively, the system may include agent runner capabilities that allow users to run custom agents across a project. This capability may enable users to select where they want to apply an agent, such as across an entire project, specific folders (with or without subfolders), or manually selected files. The agent runner capability may execute a custom agent file by file, tracking progress to allow resuming if interrupted. It may also track file hashes to detect changes and re-run agents on modified files as needed. The agent runner capability may be incorporated into IDEs and accessed via web UI, allowing companies to run and manage autonomous agents.

Additionally, or alternatively, the system may include code completion capabilities to assist developers by predicting and suggesting code snippets, functions, variable names, and/or other programming constructs as they type. The system may employ abstract syntax tree (AST)-aware contextual understanding to provide highly accurate and relevant suggestions. It may utilize a LLM trained on repository-level data to tailor completions (also referred to herein as suggestions) to specific codebases. In some examples, low-latency frontend optimizations with client-side precompute logic may be implemented to ensure code suggestions appear instantaneously for a seamless user experience.

Additionally, or alternatively, the code completion capabilities may employ a code completion pipeline including several stages. In some examples, an IDE plugin may collect context from the current editing session. As previously described, pre-compute logic and caching on the frontend may help achieve low latency. Additionally, or alternatively, a backend service may reduce context based on importance and perform pre- and post-processing. The system may use its own cloud infrastructure or third-party providers optimized for high performance. Multiple machine learning techniques may be employed to determine which embeddings in the vector database are most relevant to a given query. The system may display generated code suggestions inline with the user's input in the IDE, allowing for seamless integration into the development workflow. It may handle various user interactions, such as accepting, rejecting, or modifying suggestions, and generate additional or alternative suggestions based on this feedback.

Additionally, or alternatively, the system may include a unit testing agent that generates and verifies unit tests for existing code. Before generating tests, the agent may check if the code is testable (e.g., if the code satisfies a threshold level of testability, industry standard, and/or the like) and refactor it if needed. That is, the system may analyze existing code to identify testable components and generate appropriate test cases. It may use LLMs to create test code and may include capabilities for refactoring code to improve testability. In some examples, a unit testing agent may generate test cases in various ways. That is, test case generation may use both behavioral (black-box) and code-based (white-box) techniques. Behavioral tests may be based on method signatures, comments, and documentation, while code-based tests may analyze the implementation, logic, and code paths. That is, the generated tests may cover different types, including behavioral tests based on method signatures and documentation, as well as code-based tests that examine internal logic and code paths. After generating test cases, the agent may produce test code using codebase understanding and samples from the current project. The generated tests may be checked for correctness by analyzing IDE diagnostics and running the tests, with self-repair capabilities to address any issues.

In some examples, the system may generate an AST representing the code in the IDE and traverse it to extract detailed code syntax information. This AST-aware approach may enable more precise and context-aware code completions. The system may provide various types of code suggestions, including snippets, functions, classes, and variable names. Additionally, or alternatively, the unit test code generation process may be triggered by different events, such as user input or predefined milestones. The system may select appropriate code generation agents based on the trigger event attributes. These agents may interact with context indexing components to retrieve relevant project information and syntax awareness components to understand the existing code structure.

The system may provide feedback on test results and may use this information to suggest improvements or patches to the original code. It may also allow for user review and modification of generated test cases before finalizing the test code. This approach may enable a comprehensive and iterative process for improving code quality and test coverage.

The system may include a capability that allows automatic execution of steps suggested by coding agents without human intervention. This capability, referred to herein as “auto-pilot”, may enable autonomous code improvement and maintenance. In some examples, the auto-pilot capability may be toggled on or off (e.g., via a user interface element, a prompt, etc.) and could be incorporated with custom agent functionality. For example, a user may create a custom agent to search for and fix bugs in source code, then enable auto-pilot capability for that agent to run automatically when triggered by events like new code being added.

Additionally, or alternatively, the auto-pilot feature may be applied to other components of the system as well. For instance, it may be used in association with the context indexing component to automatically update and refine indexed context information as the codebase evolves. Similarly, a code repair tool could leverage auto-pilot to continuously monitor and patch code without manual oversight. Further, a GUI code generation agent could use auto-pilot to automatically update interface elements based on changes in application logic or user requirements. Additionally, a unit testing agent could employ auto-pilot to generate and run tests whenever code changes are detected, ensuring ongoing test coverage. While these explicit examples are described, it should be understood that the auto-pilot capability may be incorporated into any agentic-based tasks performed by the system.

Additionally, or alternatively, the system may implement one or more repository interrogation techniques to build comprehensive project documentation. This documentation may be designed to assist both human developers and AI agents in understanding the project structure, design patterns, and implementation details. For example, more robust project documentation may lead to a greater understanding of a project by an AI agent, which may result in improved responses to prompts submitted to an AI agent. In some examples, the system may proactively explore the repository, analyzing issues, user stories, project configurations and/or the like to generate summaries and/or answer high-level questions about the codebase. This may include identifying design patterns, describing application architecture, locating key components, and/or providing insights into data storage and/or access patterns.

In some examples, the overarching goal of repository interrogation is to create documentation that facilitates the efficient completion of coding tasks across various scopes, from small bug fixes to large-scale architectural updates. For example, the system may be configured to analyze the codebase to determine if design patterns are used to isolate the design layer from business logic, and if so, describe how the application is organized from that perspective, including the layers and specific design patterns used. Additionally, or alternatively, the system may also be configured to examine data storage approaches, identifying databases used, object-relational libraries or frameworks employed, and/or how database access is implemented within the application architecture. The system may leverage information from past and/or current issues, pull requests, and user stories to guide its exploration and documentation generation. Additionally, or alternatively, the system may be configured to analyze project configuration files to understand which libraries and versions are utilized, incorporating this information into the generated documentation. By providing detailed insights into the project structure and implementation details, the system aims to enhance developer productivity and improve code quality across various development tasks.

The system may employ a query expansion technique for retrieval-augmented generation (RAG) in coding tasks. When receiving a user query, such as a bug fix request, the system may generate one or more “step-back” questions to determine what information is needed to address the query. These step-back questions may be augmented with a brief project description and/or file structure overview. In some examples, the system may then use this expanded query to retrieve more relevant context from the project. This approach allows the system to consider broader project context when addressing specific coding tasks.

For example, given a user query about fixing a particular bug, the system might generate a step-back question like: “I'm working on the following project: [Project Description]. With the following file structure: [File structure, depth truncated to N-level with some indicator of the number of files in the directories that aren't expanded, overall length truncated to X-characters with “ . . . ” used to indicate that there's more]. I'm trying to help with the following request: [original user query]. What information should I find in order to succeed?” This expanded query could then be used to search through project documentation, code repositories, and/or other relevant sources to gather the most pertinent information for addressing the user's request. Additionally, or alternatively, the system may be further configured to refine this approach by experimenting with different formats and directions in the step-back question, such as asking for specific types of information or focusing on particular aspects of the project structure. By incorporating this broader context into the RAG process, the system may be able to generate more accurate and contextually appropriate code solutions, taking into account the overall project architecture, existing code patterns, and relevant documentation.

The system may include an “agent runner” capability that allows users to apply custom agents across entire projects or specific parts of a codebase. Users can select the scope of application, such as the whole project, specific folders (with or without subfolders), certain file types, or manually selected files. The agent runner capability may execute the custom agent file by file, tracking progress to allow resumption if interrupted. In some examples, the agent runner capability may also be configured to monitor file hashes to detect changes and/or re-run agents on modified files as needed. This feature may be integrated into IDEs and/or accessible via web interfaces, enabling companies to manage and run autonomous agents at scale. The agent runner capability may support both one-time executions and ongoing monitoring of codebases.

As described above, during execution of an agent runner job, the system processes files sequentially and may maintain a record of progress. This tracking mechanism enables users to resume interrupted jobs from the last processed file, enhancing resilience against system crashes, user-initiated pauses, or other disturbances. The agent runner capability also implements the file hash monitoring, allowing for selective re-execution of agents on files that have been modified since the last run. In some examples, during execution, an agent executing with the agent runner capability may maintain consistency with the standard agent interface, including features for reviewing and applying code diffs. Additionally, or alternatively, to accommodate this expanded functionality without altering the existing user interface, the system may implement a separate panel for agent runner operations. In some examples, such a modular approach facilitates future enhancements and potential decoupling from the IDE for offline agent execution.

Additionally, or alternatively, the agent runner capability may seamlessly integrate with other components of the code generation platform. For example, it may leverage the context indexing component to gather relevant project information for each file being processed. This context-aware approach enables the agent runner to generate more accurate and contextually appropriate code modifications across the specified scope. Furthermore, the agent runner can utilize various code generation agents based on the specific requirements of each file or the overall project. For instance, it might employ a refactoring agent for certain file types, a documentation agent for others, and/or a testing agent for yet another subset of files. This flexibility allows for comprehensive and tailored code improvements across large codebases.

The system also supports integration with version control systems, enabling the agent runner to work seamlessly with different branches or versions of a project. This feature allows users to apply custom agents to specific versions or compare the results of agent runs across different code iterations. In addition to its core functionality, the agent runner may be configured to generate comprehensive reports on its operations. These reports may include summaries of changes made, files processed, errors encountered, performance metrics, and/or the like. Such reporting capabilities provide valuable insights into the code modification process and can aid in project management and quality assurance efforts.

Additionally, or alternatively, the system may enhance the code embeddings described herein with usage data to provide richer context for code generation and analysis. In some examples, this approach involves enriching code representations (e.g., embeddings) by including information about where and how specific code elements (e.g., methods, classes, etc.) are used throughout the project. By traversing a dependency graph in the “used by” direction, the system can capture valuable context about the role and importance of code components. This enhancement may improve the relevance of code suggestions and assist in understanding the broader impact of code changes.

In some examples, the system may need to address challenges such as handling widely used utility methods and integrating this additional context into existing embedding models. That is, the system could experiment with different approaches for incorporating usage information into embeddings. For example, it could add usage metadata to existing code chunks and/or generate separate embeddings specifically for usage data. The system may need to carefully consider how to represent and weight usage information, especially for utility methods used in many places.

As described herein, integrating usage data with existing embedding models may require adjusting model architectures or training procedures. In some examples, the system could evaluate different methods for combining usage-based embeddings with traditional code embeddings to maximize the benefits for downstream tasks like code generation and analysis. By enriching code representations with usage context, the system may be able to generate more relevant and contextually appropriate code suggestions. Additionally, or alternatively, this enhanced context could be particularly valuable when working with complex codebases or making changes that could have wide-ranging impacts. That is, the system may be configured to leverage usage data to identify important or frequently used code components, potentially improving prioritization in code analysis tasks. Additionally, incorporating usage information may help the system better understand the relationships and dependencies between different parts of a codebase, leading to more accurate and comprehensive code generation and modification capabilities.

The techniques described may improve the functioning and efficiency of computer systems in several ways. By utilizing a context-aware approach to code generation, the system may reduce the computational resources required for generating relevant code. This may be achieved through the intelligent indexing and retrieval of contextual information, which may minimize unnecessary processing and database queries. The multi-agent architecture may allow for specialized code generation tasks, potentially reducing the overall time and processing power needed to complete complex coding projects. Furthermore, the system's ability to integrate with existing codebases and development environments may lead to more efficient use of storage resources, as it may reduce the need for redundant code storage and minimize code duplication. The implementation of large language models for code generation and understanding may improve the accuracy of generated code, potentially reducing the time and resources spent on debugging and code revisions. This increased accuracy may also enhance the overall stability and reliability of the software systems developed using this platform. The platform's capability to perform code repair and optimization may lead to improved performance of the resulting software applications. By automatically identifying and addressing inefficiencies or errors in the code, the system may contribute to creating faster, more resource-efficient applications. Additionally, the platform's ability to generate and maintain consistent user interfaces across projects may improve the overall user experience and potentially reduce the cognitive load on developers working across multiple projects. The code completion capabilities may further enhance developer productivity by providing context-aware suggestions as developers type, potentially reducing errors and speeding up the coding process. The system's ability to generate unit tests may improve code quality and reliability by automating the creation of comprehensive test suites. This may lead to earlier detection of bugs and more robust software applications.

The techniques described herein may be implemented in a number of ways. Example implementations are provided with reference to the following figures. Although discussed in the context of software development and code generation, the methods, systems, and techniques described herein may be applied to a variety of domains and are not limited to software development. For example, the context-aware and intelligent agent-based approaches may be adapted for use in areas such as natural language processing, content generation, or automated problem-solving in fields like engineering or scientific research. Additionally, while the examples focus on computer code generation, the principles of context indexing, intelligent agent selection, and error correction may be applied to other forms of content creation or data processing tasks. The techniques described herein may be used with real-world project data, simulated development environments, or any combination of the two, allowing for flexible application across various scenarios and use cases.

Additional details are described below with reference to several example embodiments.

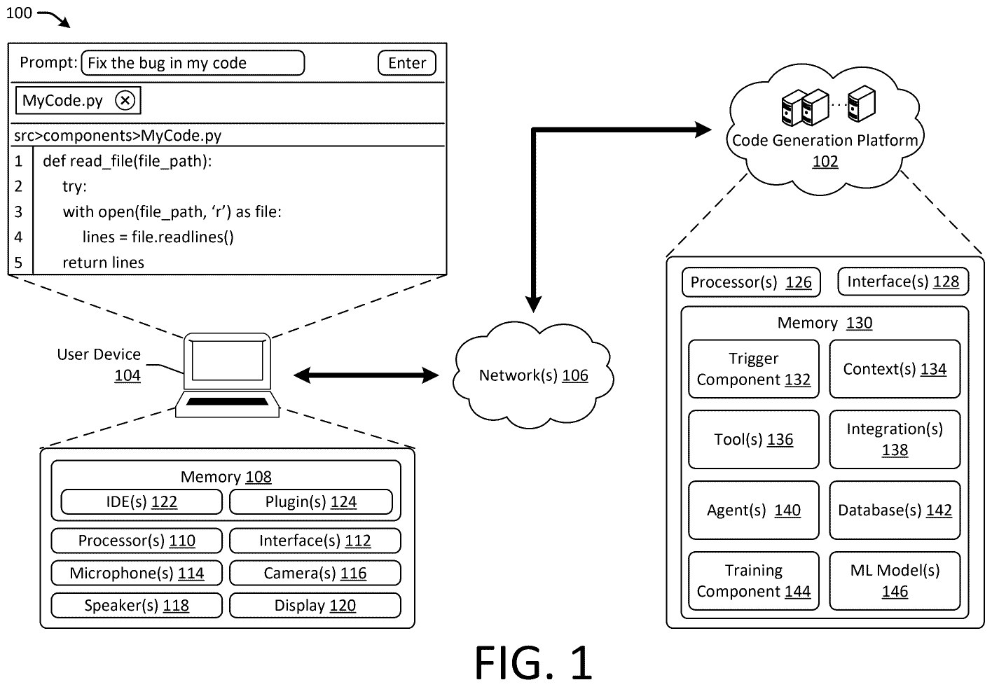

FIG. 1 illustrates an environment 100 for code generation and bug fixing, according to the techniques described herein. The environment 100 may include a code generation platform 102, one or more user devices 104, and one or more networks 106. In some examples, the code generation platform 102 may be accessible to the user devices 104 via the network(s) 106.

The user device 104 may include various components to facilitate interaction with the code generation platform 102. In some cases, the user device 104 may comprise one or more memories 108, one or more processors 110, and one or more interfaces 112. The user device 104 may also include input/output components such as a microphone 114, a camera 116, a speaker 118, and a display 120. In some examples, the memory 108 may store various data, applications, and components, such as one or more integrated development environments (IDEs) 122 and one or more plugins 124 that interface with the code generation platform described herein.

The code generation platform 102 may include one or more processors 126, one or more interfaces 128, and a memory 130. The memory 130 may store various functional components, including a trigger component 132, one or more contexts 134, one or more tools 136, one or more integrations 138, one or more agents 140, one or more databases 142, a training component 144, and one or more machine learning (ML) models 146.

In some examples, the trigger component 132 may initiate code generation or bug fixing processes based on user input or predefined events. In some examples, the trigger component 132 may monitor user activities, system events, or receive explicit requests to start code generation. The context(s) 134 may provide relevant information about the code and its environment. That is, one or more of the tools 136 may be configured to analyze project files, user preferences, coding history, and/or any other pertinent data to provide a comprehensive context 134 that is utilized by the agents 140 for code generation. The tool(s) 136 and integration(s) 138 may assist in code analysis and generation. In some examples, the tools 136 may include statistical analysis tools, code analyzers, optimizers, or specialized generators for specific programming languages or frameworks. In some implementations, the tools 136 may be extensible, allowing for the addition of new capabilities as needed. Additionally, or alternatively, the integrations 138 offered by the platform 102 may facilitate seamless interaction between the code generation platform 102 and external systems or services. These integrations 138 may enable the platform 102 to access version control systems (e.g., GitHub), issue trackers (e.g. Jira), and/or other development tools commonly used in software projects.

The agent(s) 140 may execute specific tasks in the code generation or bug-fixing process. In some examples, the agent(s) 140 may be AI-powered components responsible for generating, modifying, and/or optimizing code based on the provided context and user requirements. In some examples, multiple specialized agents may be available, each tailored to specific coding tasks or programming paradigms. For example, agent(s) 140 may be configured as a bug fixing agent, a continuous integration and continuous delivery (CI/CD) agent, an onboarding agent, a code review agent, a UI generation agent, a database management agent, a documentation agent, a testing agent, a security review agent, a refactoring agent, a migration agent, a question answering agent, an environment management agent, and/or a custom agent defined by the user. In some cases, the agent(s) 140 may leverage machine learning models to analyze code patterns and suggest improvements. The agent(s) 140 may interact with other components of the system, such as a context indexer, to gather relevant information for code generation tasks. Additionally, the agent(s) 140 may be designed to work collaboratively, with multiple agents potentially contributing to a single code generation or bug-fixing task. The flexibility of the agent architecture may allow for the creation of new specialized agents as needed, expanding the system's capabilities over time. In some implementations, the agent(s) 140 may also include natural language processing capabilities to interpret user requirements and generate appropriate code responses.

The database(s) 142 may store relevant information for code generation and bug fixing. In some examples, the database(s) 142 may contain indexed context information associated with computer code generation sessions, including project data such as existing computer code, latest changes, logs, text data, file structure data, open file information, and project documentation related to user accounts. Additionally, the database(s) 142 may store embeddings generated from this indexed context information, which can be queried by code generation agents 140 to support the code generation process(es). The database(s) 142 may also include vector databases configured to store and efficiently retrieve embeddings representing various types of data, including external documentation, user-specific information, and company-specific data. In some cases, the database(s) 142 may store environmental data associated with code generation sessions, such as information about installed libraries, operating systems, and databases utilized by user accounts. The database(s) 142 may also maintain libraries of custom computer code generation agents 140 created by users, allowing for the storage and retrieval of specialized agents for future use. Furthermore, the database(s) 142 may store diagnostic data, feedback information, and patched code versions to support code repair and optimization processes.

In some examples, the code generation platform 102 may employ various techniques to improve its code generation and bug fixing capabilities. For example, the platform may utilize context-aware code generation, leveraging the context(s) 134 to produce more relevant and accurate code. The platform may also implement adaptive learning strategies, using the training component 144 and ML model(s) 146 to continuously refine its understanding of coding patterns, best practices, and common errors. For example, the training component 144 may analyze user interactions, code generation results, and bug fixing outcomes to refine the ML model(s) 146. This may allow the code generation platform 102 to adapt and enhance its performance based on accumulated experience and feedback. In some examples, the training component 144 may collect feedback data over periods of time and generate training datasets from this collected data. The training component 144 may then use these datasets to generate trained ML models. In some implementations, the platform 102 may evaluate the performance of the trained models and determine whether to utilize them for subsequent code generation and bug fixing tasks. This iterative improvement process may help the platform 102 continuously evolve its capabilities to better meet user needs and handle increasingly complex coding scenarios. The adaptive nature of the system may enable it to stay current with emerging coding practices, new programming languages, and evolving software development methodologies.

The system may allow for bidirectional communication between the user device 104 and the code generation platform 102 through the network 106. This may enable the platform 102 to receive user code and prompts, process requests, and return generated or fixed code to the user's device 104.

The code generation platform 102 may support multiple programming languages and frameworks, adapting its code generation and bug fixing techniques to the specific requirements of each language or framework. In some cases, the platform may also provide explanations or documentation for the generated or fixed code, enhancing its educational value for users.

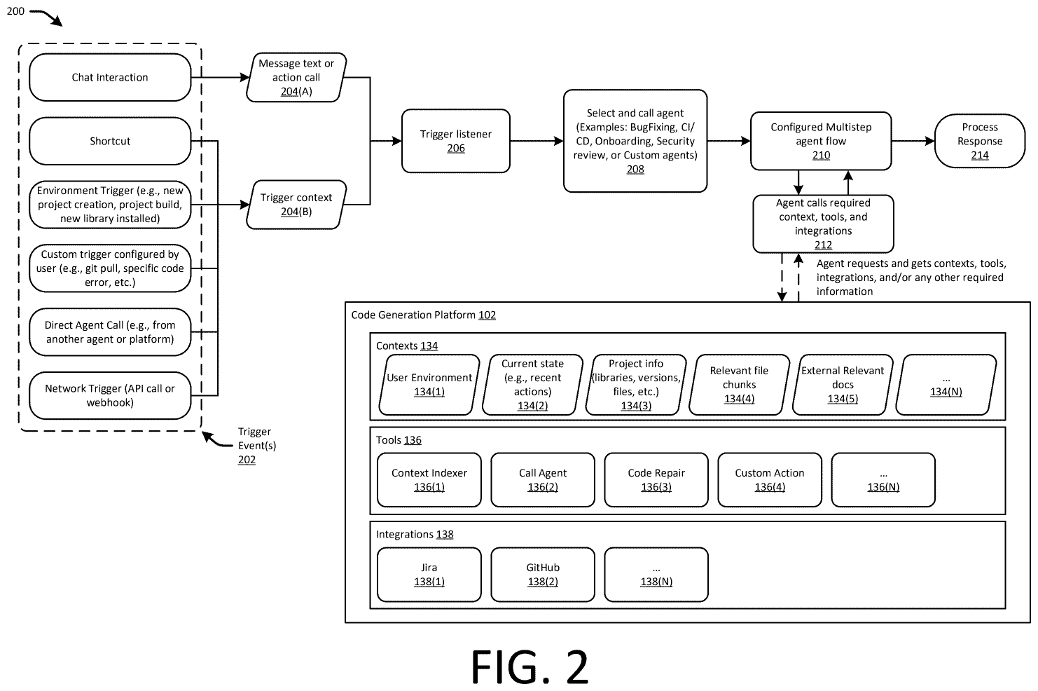

FIG. 2 illustrates an example flow diagram of a process 200 for generating and processing code using a code generation platform 102. In some examples, the code generation platform 102 may contain several components that support this process 200. For example, the code generation platform 102 may comprise context(s) 134, which may comprise various context associated with a user environment 134(1), a current state 134(2), project info 134(3), relevant file chunks 134(4), external relevant docs 134(5), recent changes and actions, and/or additional contexts 134(N). Additionally, or alternatively, platform 102 may include various tools 136 which may be leveraged by the agents, including a context indexer 136(1), call agent 136(2), code repair 136(3), custom action 136(4), and/or additional tools 136(N). Additionally, or alternatively, the platform 102 may support various integrations 138 that provide connections to external services. For example, the platform 102 may integrate with issue tracking systems such as Jira 138(1), version control systems like GitHub 138(2), project management systems like Asana, CI/CD tools like Jenkins, build tools like Maven, compilers like Javac, static code analysis tools like SonarQube, security analysis tools like Snyk, application performance management tools like Sentry, container tools like Doker, cloud suites like Google Cloud, various commands available through the IDE like VSCode, shells like Bash, file editing tools, unit testing tools like Junit, and many others. Additionally, the platform 102 may support additional integrations 138(N), which may include other development tools, project management software, or any other relevant external services.

The process 200 may begin based on trigger events 202, which can originate from various sources. In some examples, these trigger events 202 may include chat interactions, shortcuts, environment triggers (e.g., when a new project is created, a project build operation is executed, or a new library is installed), custom triggers configured by a user (e.g., a git pull operation or a specific code error), direct agent calls (e.g., from another agent or platform), and/or network triggers (e.g., an API call or webhook).

In some cases, these trigger events 202 may generate one of a message text or action call 204(A) and/or a trigger context 204(B). A trigger listener 206 may receive the input from 204(A) or 204(B) as a result of a trigger event 202 and initiate the next step in the process. At 208, based on the trigger, an agent may be selected and called. In some examples, this may involve selecting agents for various purposes such as bug fixing, continuous integration, onboarding, or security reviews.

At 210, the selected agent may initiate a multistep agent flow. In some examples, the multistep agent flow 210 may involve collaboration between multiple specialized agents, each focusing on a specific aspect of the code generation task. These agents may exchange information and intermediate results as part of the overall flow, leveraging the platform's ability to manage complex, multi-agent processes. That is, the multistep agent flow 210 may be designed to handle complex code generation tasks that require multiple stages of processing or interaction with various components of the system. In some cases, the flow may involve iterative steps, where the agent refines its output based on feedback or additional context gathered during the process.

As part of this multistep agent flow 210, at 212, the agent may call required context, tools, and integrations. This step may involve the agent requesting and receiving contexts 134, tools 136, integrations 138, and/or any other required information from the platform 102. Additionally, or alternatively, at 212, when calling required context(s) 134, tool(s) 136, and/or integrations 138, the agent may utilize different combinations of resources depending on the specific task at hand. For instance, in some examples, the agent may prioritize certain types of context information based on the nature of the code generation request. The agent may also selectively employ specific tools 136 that are most relevant to the current task. The integration with external services such as Jira 138(1) and GitHub 138(2) may allow the agent to access and incorporate project-specific information into the code generation process. For example, the agent may retrieve issue details from Jira 138(1) to better understand the requirements of the code being generated. Similarly, integration with GitHub 138(2) may enable the agent to consider existing codebase structure, commit history, or branch information when generating new code.

After the agent completes its tasks using these resources, at 214 the response may be processed, concluding the workflow of the code generation platform system. The processed response may include generated code, suggestions for code improvements, and/or other relevant outputs based on the initial query and the resources utilized during the multistep agent flow 210.

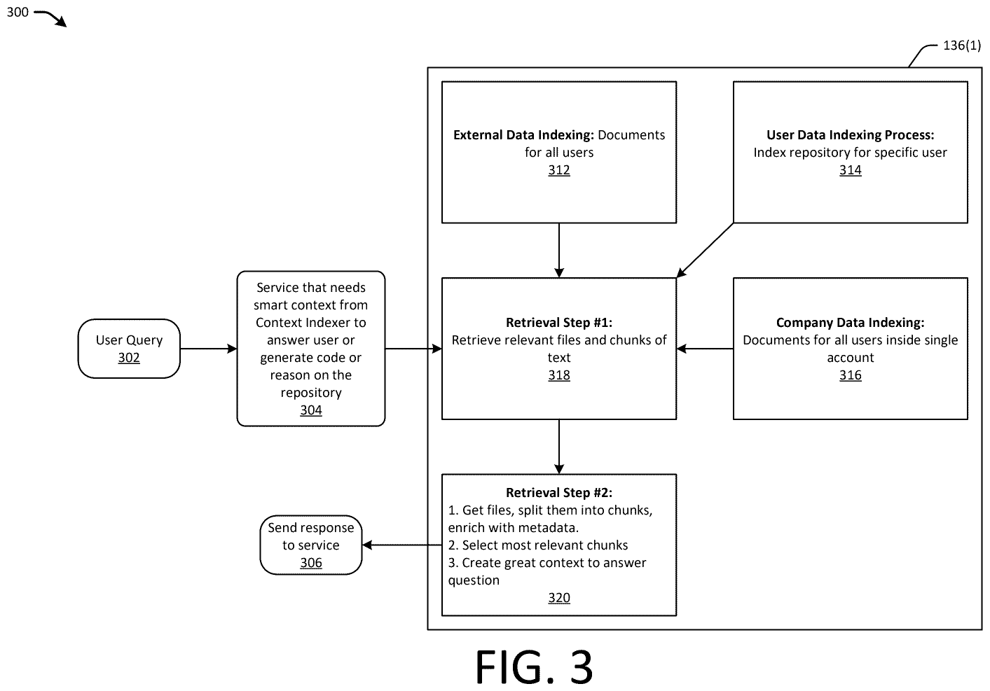

FIG. 3 illustrates a flow diagram of an example process 300 performed by the context indexer 136(1), which may be part of a larger process performed by the code generation platform 102 (e.g., part of the process 200 as described with respect to FIG. 2). The context indexer 136(1) may be configured to process and index various types of data to provide smart context for answering user queries or generating code based on the repository.

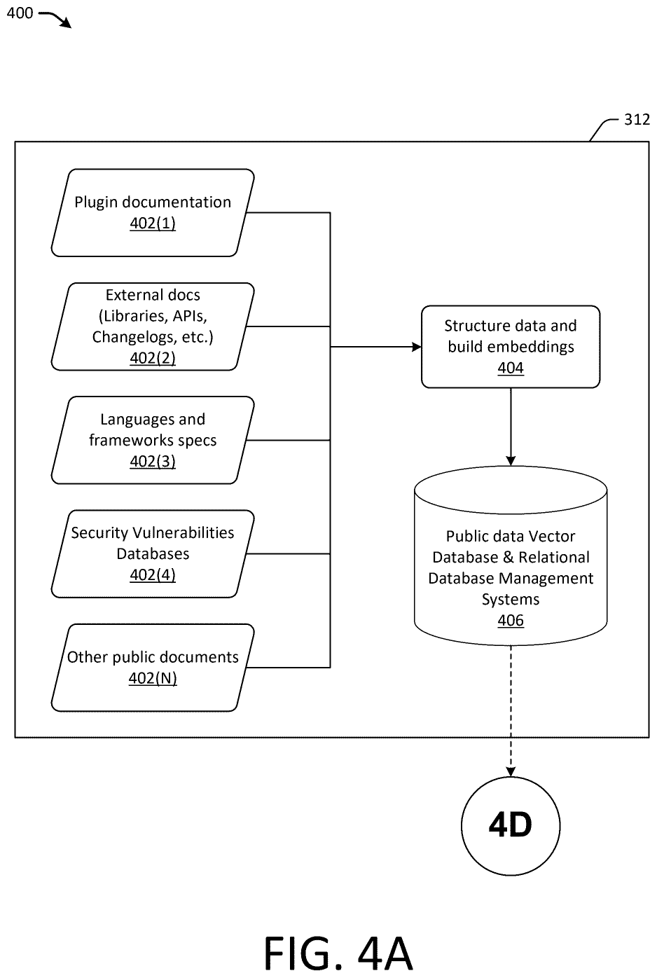

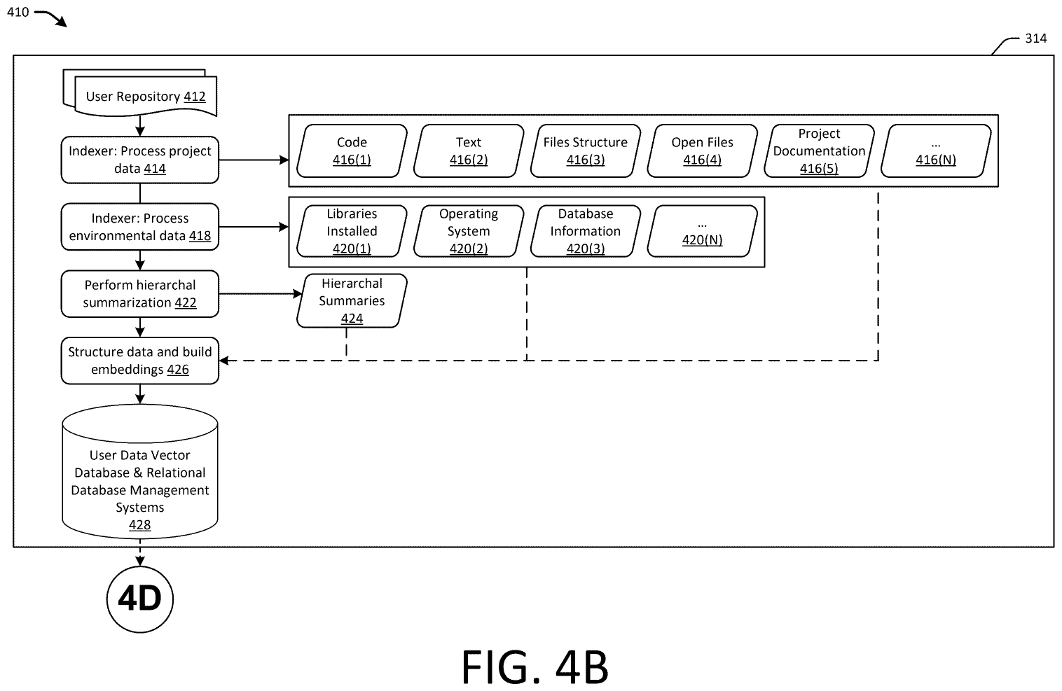

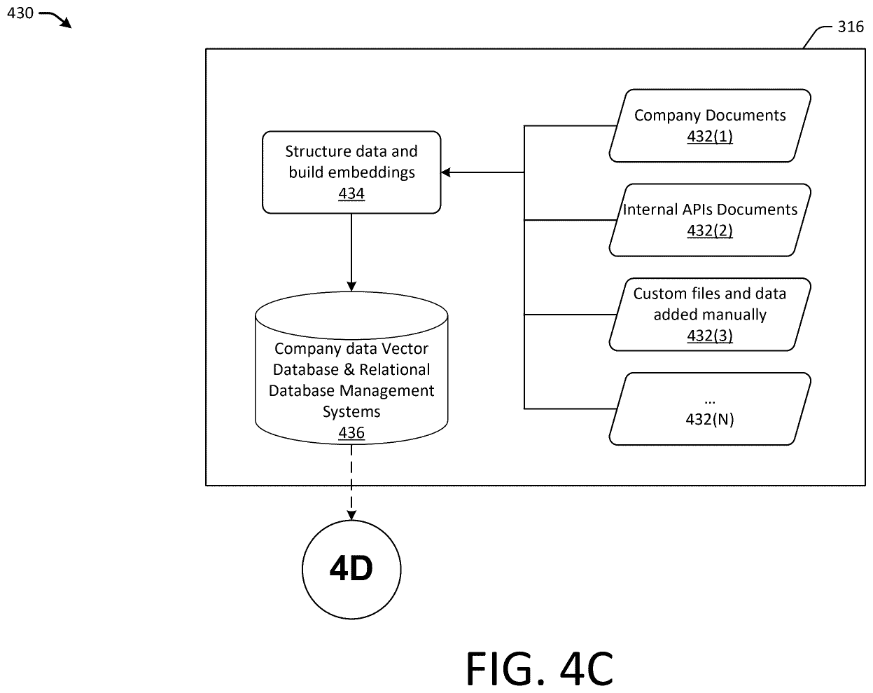

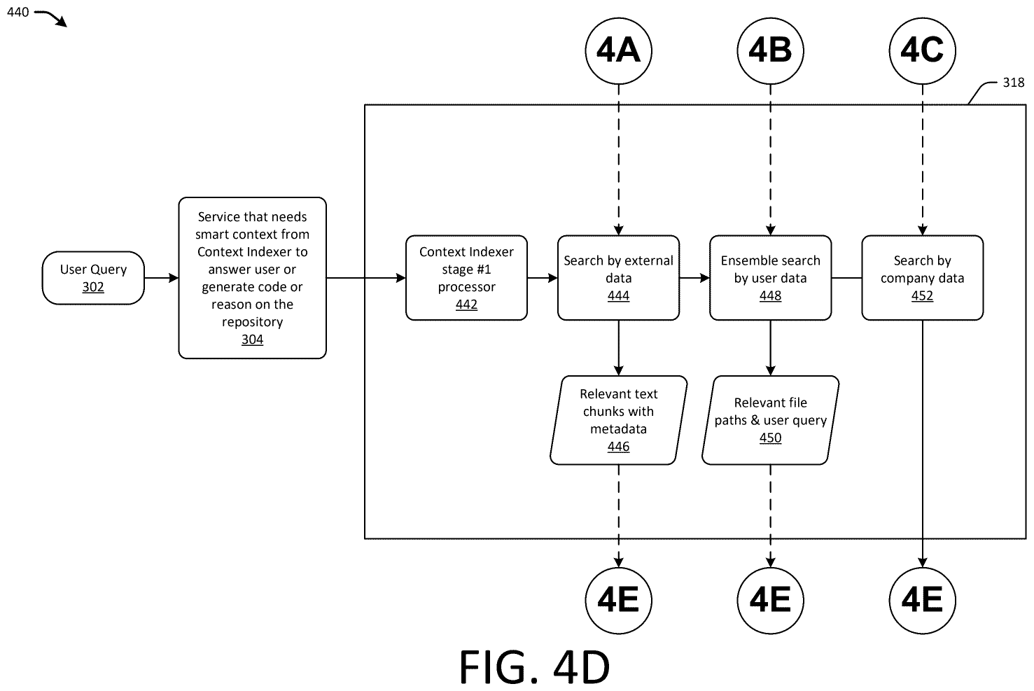

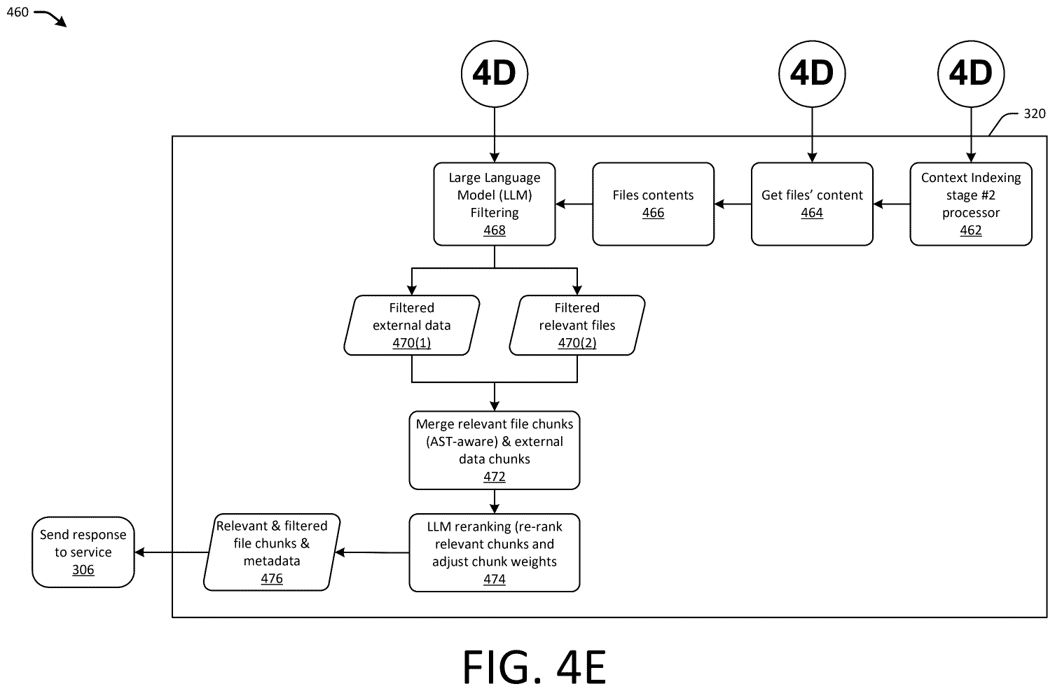

In some examples, the process 300 may begin when a user query 302 is received. While the process 300 is illustrated as starting with a user query 302, the process 300 may begin as a result of a trigger event, such as, for example, the trigger events 202 as described with respect to FIG. 2. The user query 302 may be handled by a service 304 that requires smart context from the context indexer 136(1) to answer the user query or generate code in response to the user query based on the repository. The context indexer 136(1) may comprise various sub-processes for data indexing, such as an external data indexing sub-process 312, a user data indexing sub-process 314, and/or a company data indexing sub-process 316, each of which are described in more detail below with respect to FIGS. 4A-4C. In some examples, the external data indexing sub-process 312 may handle documents for all users, the user data indexing sub-process 314 may index repository data for a specific user, and/or the company data indexing sub-process 316 may process documents for all users inside a single account. Additionally, or alternatively, these sub-process(es) 312, 314, 316 may be executed in parallel in response to the context indexer 136(1) to receiving a request for smart context.

Take, for example, a selected code generation agent requesting indexed context information from the context indexer 136(1). The context indexer 136(1) may generate the indexed context information according to a first indexing schema based on the selected code generation agent. This approach allows for tailored context generation that may be optimized for the specific needs of different code generation agents. The indexed context information may include project data associated with the computer code generation session. This project data may comprise existing computer code associated with a user account, text data associated with the user account, file structure data associated with the user account, open file information associated with the user account, and/or project documentation associated with the computer code generation session. In some examples, the context indexer 136(1) may utilize different indexing schemas depending on the type of code generation agent selected or the nature of the query received. For example, a second indexing schema that differs from the first indexing schema may be utilized when a different code generation agent is selected. This flexibility allows the system to adapt its context generation approach to best suit the requirements of various code generation tasks. The agent can also specify what type of data it prefers to receive taking an active role in this process.

The process 300 continues as the context indexer 136(1) may perform a first retrieval step sub-process 318, which may retrieve relevant files and/or chunks of data based on the indexed data from the three data sources. Additionally, or alternatively, the context indexer 136(1) may perform a second retrieval step sub-process 320, which may further process the retrieved data by getting files, splitting them into chunks, enriching them with metadata, selecting the most relevant chunks, and creating a comprehensive context to answer the question. The first retrieval step sub-process 318 and/or the second retrieval step sub-process 320 are described in more detail below with respect to FIGS. 4D and 4E.

After the second retrieval step, the system may send a response to the service 306, which can then use this context to generate an appropriate answer or code for the user query. The context indexer 136(1) may be designed to efficiently process and utilize various data sources to provide relevant and accurate responses to user queries or assist in code generation tasks. In some examples, the context indexer 136(1) may be configured to generate indexed context information (e.g., execute sub-processes 312, 314, and/or 316) prior to receiving the first data indicating the trigger event. In some examples, this pre-generation of indexed context information allows for faster response times when a code generation request is received.

The context indexer 136(1) may select a subset of the first embeddings to utilize for generating the indexed context information requested during the computer code generation session based at least in part on the trigger event (e.g., the user query 302). In some examples, the first embeddings may represent various types of information, such as existing computer code associated with the user account, text data associated with the user account, file structure data associated with the user account, open file information associated with the user account, and project documentation associated with the computer code generation session. Additionally, the first embeddings may include representations of external data like plugin documentation, languages and frameworks specifications, security vulnerability information, and related public documents. The selection of the subset may be tailored to provide the most relevant context for the specific code generation task initiated by the trigger event.

In some examples, the context indexer 136(1) may generate the indexed context information according to a first indexing schema based at least in part on attributes of the user query 302. For example, when the user query 302 comprises receiving a request for code generation, the system may analyze the attributes of the request to determine the most appropriate indexing schema. The indexed context information may be generated according to a second indexing schema when other request attributes are identified. This flexibility allows the context indexer 136(1) to tailor the context generation process to the specific needs of each code generation task. That is, the use of different indexing schemas allows the context indexer 136(1) to optimize the relevance and efficiency of the generated context for various scenarios. For instance, a code generation request related to bug fixing may require a different context structure compared to a request for generating new features. By adapting the indexing schema, the context indexer 136(1) can prioritize the most relevant information for each specific task.

In some cases, the context indexer 136(1) may utilize machine learning techniques to dynamically adjust and refine the indexing schemas over time. This may involve analyzing the effectiveness of different schemas for various types of code generation tasks and automatically adjusting the schemas to improve performance. The context indexer 136(1) may also consider factors such as user preferences, project-specific requirements, or organizational guidelines when selecting or generating an appropriate indexing schema. This customization can help ensure that the generated context aligns with the specific needs and conventions of the development team or organization.

FIG. 4A illustrates a flow diagram 400 of an external data indexing sub-process 312. The sub-process 312 may be part of a larger process 300 performed by the context indexer 136(1), as described with respect to FIGS. 1-3. In some examples, the sub-process 312 may be designed to structure and index various types of external data for use in a public data vector database and relational database management system.

At 402, the sub-process 312 may include collecting data from different types of external data sources. In some examples, the external data sources may include plugin documentation 402(1), external documentation 402(2) (e.g., libraries, APIs, changelogs, etc.), languages and frameworks specifications 402(3), security vulnerabilities databases 402(4), and/or other public documents 402(N).

At 404, the context indexer 136(1) may generate embeddings from the indexed external data 402. These embeddings may be vector representations of the textual data, allowing for efficient storage and retrieval of information. In some examples, the external data sources 402(1)-(N) may be fed into a central processing component where the data is structured and embeddings are built. This central processing component may be responsible for organizing the data received from the external data sources 402, and creating embeddings. These embeddings may be vector representations of the data, allowing for efficient storage and retrieval of information. The embeddings may capture semantic relationships and contextual information from the indexed external data, enabling more effective querying and utilization of the data during code generation tasks. The generation of embeddings from indexed external data may involve various techniques, such as using pre-trained language models or custom embedding algorithms tailored to the specific types of external data being processed. In some cases, the platform may employ different embedding strategies for different types of external data, optimizing the representation for each data source.

At 406, the structured data and embeddings may then be stored in a vector database. This database may be configured as a storage system that combines vector database capabilities with traditional relational database management systems. The vector database may be configured to handle various types of embeddings, enabling seamless integration of project-specific and external information in code generation processes. In some examples, the public vector database may be leveraged by additional components and/or platforms, as described in more detail below with respect to FIG. 4D. This approach may allow for the efficient retrieval and utilization of relevant external data during code generation tasks, enhancing the context-aware capabilities of the system.

By storing these embeddings derived from indexed external data, the code generation platform 102 may enhance its ability to generate contextually relevant and up-to-date code. The platform may leverage this external knowledge to suggest best practices, identify potential security vulnerabilities, or incorporate the latest language features and frameworks into the generated code.

FIG. 4B illustrates a flow diagram 410 of a user data indexing sub-process 314, which may be part of a larger process 300 performed by the context indexer 136(1), as described with respect to FIGS. 1-3. The sub-process 314 may be designed to structure and index various types of user data for use in a user data vector database and relational database management system.

In some examples, the process 314 may begin when a user repository 412 is fed into the context indexer 136(1). For example, at 414, the context indexer 136(1) may process various types of project data 416. The project data 416 may include code 416(1), text 416(2), file structure(s) 416(3), open files 416(4), project documentation 416(5), and/or additional project data 416(N), such as, for example, recent changes in the code, user interface screens and/or wireframe(s) included in documentation, and/or the like. The context indexer 136(1) may analyze and process this information to generate indexed context information associated with the computer code generation session.

In parallel, at 418, the context indexer 136(1) may process environmental data 420 associated with the user environment. This environmental data 420 may include libraries installed 420(1), operating system 420(2), database information 420(3), and/or additional environmental data 420(N), such as, for example, deployment scripts and/or configuration data including virtualization and/or containerization information. The context indexer 136(1) may analyze and process this information to generate indexed environmental information associated with the computer code generation session.

At 422, the sub-process 314 may then perform hierarchical summarization and extraction of relevant information, which generates hierarchical summaries 424. In some examples, the hierarchical summaries 424 may provide a better representation of the project. For example, a hierarchical summary 424 may be configured as an architecture diagram representing the architecture of a given project. In some cases, this hierarchical summarization may be based on the file structure data 416(3), creating a representation of the associations between files and their hierarchy within the project structure. In some examples, the context indexer 136(1) may identify files associated with the user environment, such as files stored on the user's device 104 or accessible through the user's account. This identification process may involve scanning local storage, accessing cloud-based repositories, or interfacing with version control systems associated with the user's projects. Once the files are identified, the context indexer 136(1) may determine a file structure of the files from the file structure data 416(3). In some cases, this determination may involve analyzing directory hierarchies, file naming conventions, and relationships between different file types. The file structure may indicate associations between the files in the file structure and a hierarchy of the files in the file structure. For example, the context indexer 136(1) may recognize project folders, source code directories, resource folders, and configuration files, establishing their relative positions within the overall project structure.

As described above, the context indexer 136(1) may generate hierarchical summaries 424 of the file structure. These summaries 424 may provide a condensed representation of the project's organization, highlighting key structural elements while abstracting away less relevant details. The hierarchical summaries 424 may capture relationships between different components of the project, such as dependencies between modules, inheritance structures in object-oriented code, connections between front-end and back-end components, and/or connections to data-base. These summaries 424 may also include extracting the information about different languages and libraries used, including their correct versioning. Additionally, or alternatively, these summaries 424 may create synthetic information, such as architecture diagrams, summaries, and/or specifications from information extracted from the code. The generation of the hierarchical summaries 424 may involve various techniques, including prompting LLMs to extract relevant data, or leveraging code graphs such as abstract syntax tree and dependencies. Correspondingly, it may include information about the entity derived from the overall project information, such as where and how said entity is used, significantly enriching local and global context. In some examples, the context indexer 136(1) may employ tree-based algorithms to represent the file structure, with nodes representing directories and leaves representing individual files. The summarization process may involve pruning less significant branches, collapsing repetitive structures, or highlighting frequently accessed or modified parts of the file structure.

Additionally, or alternatively, the hierarchical summaries 424 may incorporate metadata about the files and directories, such as file sizes, modification dates, or version control information. This additional context may enhance the relevance of the summarization for code generation tasks, allowing the system to prioritize more recent or frequently modified parts of the project. The context indexer 136(1) may also analyze file contents to inform the hierarchical summarization. For instance, it may identify key classes, functions, or modules within source code files and represent their relationships in the summarization. This deeper analysis may provide valuable context for code generation tasks that require understanding of the project's internal structure and dependencies.

The hierarchical summaries 424 may be dynamically updated as the file structure changes. The context indexer 136(1) may monitor for file system events, such as file creation, deletion, or modification, and adjust the summarization accordingly. This dynamic approach may ensure that the context provided for code generation tasks remains current and relevant. The hierarchical summaries 424 generated by the context indexer 136(1) may serve as a valuable input for various code generation tasks. It may help code generation agents 140 understand the overall structure of the project, locate relevant files or components, and generate code that integrates seamlessly with the existing project organization. The summaries 424 may also assist in tasks such as refactoring, where understanding the project structure is crucial for making widespread changes while maintaining consistency.

At 426, the sub-process 314 may structure the data and build embeddings. This step may involve generating embeddings from the indexed project information, the indexed environmental information, and/or the hierarchical summaries, as processed by the context indexing component. These embeddings may be vector representations of the various types of data, allowing for efficient storage and retrieval. Additionally, or alternatively, individual embeddings may be generated for each of the indexed project information, the indexed environmental information, and/or the hierarchal summaries. In some cases, this approach of generating separate and/or several embeddings for different data types may allow for more granular and targeted retrieval of relevant information during code generation tasks.

At 428, the structured data and embeddings may then be stored in a user data vector database and RDMS (Relational Database Management System). This database 428 may be configured to be queried by the code generation agent to generate computer code. By storing the data in this format, the system may enable rapid and relevant retrieval of context information during code generation tasks.

In some examples, the user data indexing sub-process 314 may be executed periodically or in response to specific triggers, ensuring that the indexed information and embeddings remain up-to-date. The process may also incorporate version control information, allowing the system to track changes in the project data over time. The sub-process 314 may be designed to handle various programming languages and project structures, adapting its indexing and embedding strategies based on the specific characteristics of each user repository. This flexibility may allow the system to provide relevant context for code generation across a wide range of development environments and project types.

FIG. 4C illustrates an example flow diagram 430 of a company data indexing sub-process 316. The sub-process 316 may be part of a larger process 300 performed by the context indexer 136(1), as described with respect to FIGS. 1-3. In some examples, the sub-process 316 may be designed to structure and index various types of company data for use in a company data vector database and relational database management system.

The flow diagram 430 begins by the sub-process 316 leveraging several company data sources to index company data. In some examples, the company data sources may include company documents 432(1), internal API documents 432(2), custom files and data added manually 432(3), and/or additional data sources 432(N). In some cases, company documents 432(1) may include internal memos, project reports, employee handbooks, or other proprietary documents specific to the organization. Internal API documents 432(2) may comprise documentation for custom APIs developed within the company, including specifications, usage guidelines, and endpoint descriptions. Custom files and data added manually 432(3) may represent any user-specific or project-specific data that has been manually input into the system, such as code snippets, configuration files, or specialized datasets. Additional data sources 432(N) may include any other relevant company-specific information, such as internal wikis, knowledge bases, or legacy system documentation.

At 434, the context indexer 136(1) may structure the data and build embeddings based on processing the input from the various data sources 432(1), 432(2), 432(3), and 432(N). This step may involve organizing the data and creating vector representations (embeddings) of the information for efficient storage and retrieval. The structuring process may include tasks such as text normalization, entity recognition, and relationship extraction to enhance the quality of the resulting embeddings. In some examples, the context indexer 136(1) may employ different embedding techniques depending on the nature of the data, such as using specialized models for code-related content versus natural language text.

At 436, the structured data and embeddings may be stored in a company data vector database and RDMS (Relational Database Management System). This database may be configured as a storage system that combines vector-based and relational database technologies. The vector database component may allow for efficient similarity searches and retrieval of relevant information based on the generated embeddings, while the relational component may maintain the structured relationships between different data elements.

That is, flow diagram 430 tracks the company indexing sub-process 316 and illustrates the flow of information from the various sources 432(1), 432(2), 432(3), and 432(N) that are used to structure data and build embeddings 434, which are then stored in the company data vector database and RDMS 436. In some examples, the company data vector database 436 may be leveraged by additional components and/or platforms, as described in more detail below with respect to FIG. 4D.

By incorporating company-specific data into the context indexing process, the platform 102 may enhance its ability to generate contextually relevant code that aligns with the organization's standards, practices, and existing codebase. The structured and embedded company data may allow code generation agents to access and utilize internal knowledge efficiently, potentially improving the accuracy and relevance of generated code within the specific company environment. Additionally, the integration of company data may enable the system to maintain consistency with internal coding standards and practices, facilitating easier integration of generated code into existing projects.

FIG. 4D illustrates an example flow diagram 440 of a first retrieval step sub-process 318, which may be part of a larger process 300 performed by the context indexer 136(1), as described with respect to FIGS. 1-3. In some examples, the sub-process 318 may be designed to retrieve relevant files and chunks of text.

The flow diagram 440 may begin when a user query 302 is received. In some examples, the user query 302 may be handled by a service 304 that requests smart context from a context indexer (e.g., context indexer 136(1)) to answer the user or generate code or reason on the repository. The service 304 may forward the query to a context indexer stage 1 processor at 442, which may initiate a series of search operations. The processor 442 may coordinate various searches, such as, for example, an external data search 444, an ensemble search by user data 448, and/or a company data search 452.

At 444, an external data search may be performed to retrieve external data represented as structured data and embeddings stored in the public data vector database from the sub-process 312, as described with respect to FIG. 4A. At 446, the sub-process 318 may generate output representing relevant text chunks with metadata by processing the query along with the retrieved external data. These text chunks may represent pertinent information extracted from plugin documentation, external documents, language specifications, security vulnerability databases, and other public documents.

At 448, an ensemble search by user data may be performed to retrieve user data represented as structured data and embeddings stored in the user data vector database from the sub-process 314, as described with respect to FIG. 4B. At 450, the sub-process 318 may generate output representing relevant file paths and the user query 450. These file paths may correspond to existing computer code, text data, file structures, open files, and project documentation associated with the user account.

At 452, the ensemble search may include a search by company data 452 that is performed to retrieve company data represented as structured data and embeddings stored in a company data vector database from the sub-process 316, as described with respect to FIG. 4C. This company data search may complement the ensemble search, providing context from company-specific documents, internal API documentation, and custom files.

The outputs from the external data search 444, the ensemble search 448, and/or the search by company data 452 may be later leveraged by a second retrieval step sub-process 320, as described in more detail with respect to FIG. 4E. In some examples, the context indexer stage 1 processor 442 may employ various techniques to optimize the search processes 444, 448, 452. For example, it may use relevance scoring algorithms to rank the retrieved information, ensuring that the most pertinent data is prioritized. The processor 442 may also implement caching mechanisms to improve response times for frequently requested information.

The first retrieval step sub-process 318 may be designed to handle various types of queries, from specific code-related questions to broader requests for project context. In some cases, the sub-process 318 may adapt its search strategies based on the nature of the query, potentially emphasizing certain data sources over others depending on the context of the request.

FIG. 4E illustrates an example flow diagram 460 of a second retrieval step sub-process 320, which may be part of a larger process 300 performed by the context indexer 136(1), as described with respect to FIGS. 1-3. This sub-process 320 may enhance the relevance and quality of the retrieved information before it is utilized by the requesting service.

The flow diagram 460 begins with a context indexing stage 2 processor 462, which initiates the retrieval of files' contents 464, resulting in the reception of the necessary file contents 466. These file contents 466 may be based on the outputs and/or results from the search by user data 448 and/or the search by company data 452 of the first retrieval step sub-process 318, as described with respect to FIG. 4D. The file contents 466 and/or the relevant text chunks with metadata 446 retrieved as a result of the search by external data 444 of the sub-process 318, as described with respect to FIG. 4D, are then passed to a Large Language Model (LLM) configured to filter the input(s) and generate output(s).

At 468, the LLM processes the input(s) (e.g., the file content(s) 466 and/or the relevant text chunks with metadata 446) and may produce output(s), such as, for example filtered external data 470(1) and/or filtered relevant files 470(2). In some examples, the LLM filtering 468 may analyze the file contents 466 and/or relevant text chunks 446 to determine their relevance to the original query or context. The filtering process may involve removing irrelevant information, extracting key concepts, or reformatting the data for easier consumption by subsequent steps. When using LLM for filtering, one can utilize both the “token” (e.g., text) results of the LLM processing, and the internal values generated by the model (e.g., log probabilities of such tokens), for example, if LLM is asked whether a chunk is relevant, one can look both at the structured output (e.g., Yes/No), as well as at the log probability of the “Yes” token.

At 472, these filtered outputs are then merged, which combines relevant file chunks and external data chunks. In some cases, this merging process may be Abstract Syntax Tree (AST)-aware, allowing for a more intelligent combination of code-related information. The merging process may consider the structure and semantics of the code, potentially improving the relevance of the merged data for code-related queries. It's important to note that the exact sequence of processing steps might be modified and/or reversed.

At 474, the merged data undergoes an LLM re-ranking process. The LLM may be configured to re-rank the relevant chunks and adjusts chunk weights to prioritize the most relevant information. The LLM re-ranking may utilize probabilities to determine the relevance of each chunk. These probabilities may be based on various factors such as semantic similarity to the original query, frequency of key terms, or the chunk's position within the original document structure. For example, a code snippet that closely matches the functionality described in the query may receive a higher probability and thus a higher ranking. One may use another re-ranker at this step, such as, for example, a cross-embedding re-ranker that is trained on the relevance of such chunks for the downstream AI task. As mentioned before, the exact sequence of processing steps might be modified and/or reversed (e.g., enrich>rerank>filter, rerank>enrich>filter, first pass>rerank and pick TOP to add to the query>second pass>filter>rerank, etc).

Output of this reranking process is generated as relevant and filtered file chunks and metadata 476. These relevant and filtered file chunks and metadata 476 may represent the most pertinent information from both the filtered external data and the filtered relevant files, now organized in order of relevance as determined by the LLM reranking process.

At 306, the relevant and filtered file chunks and metadata 476 is sent as a response to a service, completing the second retrieval step sub-process 320 and/or the final step of the process 300 as described with respect to FIG. 3. In some examples, the relevant and filtered file chunks and metadata 476 may be configured as the smart context requested by the service in process 300 as described with respect to FIG. 3. This smart context may provide a comprehensive and highly relevant set of information that can be utilized by the code generation platform 102 to produce more accurate and context-aware code or responses.

The second retrieval step sub-process 320 demonstrates the system's ability to not only gather relevant information but also to refine and prioritize that information using advanced language models. This process may significantly enhance the quality and relevance of the context provided to the code generation platform, potentially leading to more accurate and useful code generation or query responses.

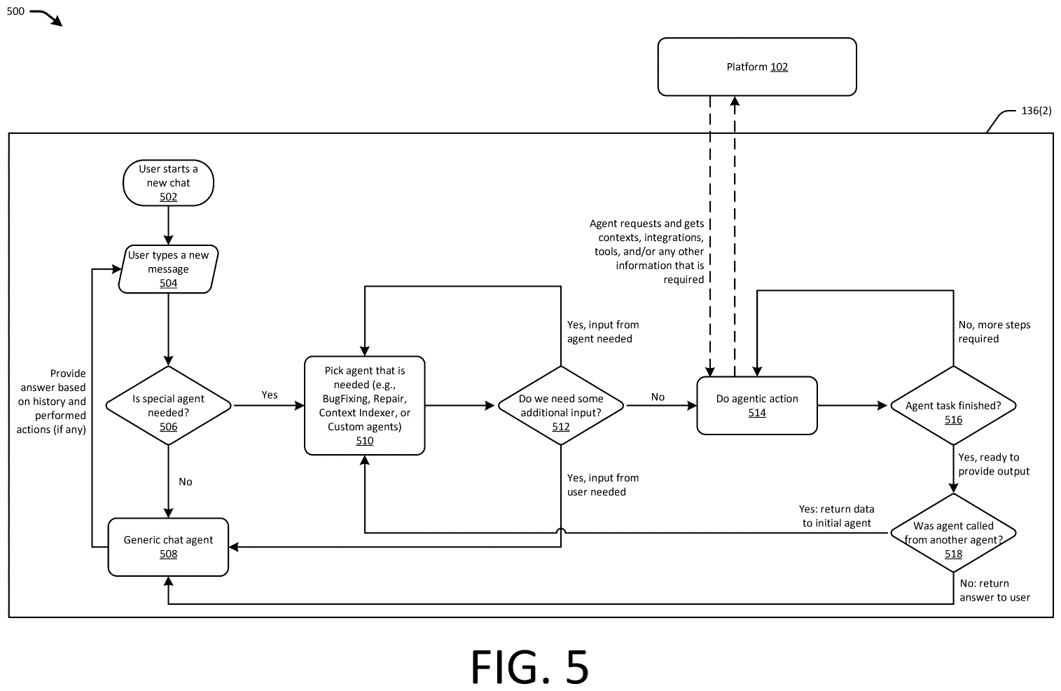

FIG. 5 illustrates a flow diagram of an example process 500 performed at least partly by a call agent tool 136(2) for calling and utilizing agents within the code generation platform 102 disclosed herein. The example process 500 illustrates the flexibility and power of the code generation platform's 102 multi-agent architecture. By dynamically selecting and coordinating different agents based on the specific requirements of each task, the platform 102 can provide tailored assistance for a wide range of software development needs. This approach allows for the seamless integration of various specialized components, such as context indexing, code repair, and custom actions, to deliver comprehensive and context-aware solutions to users.

The process 500 may begin at 502, when a user starts a new chat. In some examples, this may involve the user opening a chat interface within an integrated development environment (IDE) (e.g., offered as a plugin) or a standalone application connected to the code generation platform 102. At 504, the user may type a message, which may contain a query or request related to code generation, bug fixing, or other software development tasks.

At 506, the process 500 includes a decision point, where the platform 102 determines if a special agent is needed to handle the user's request. This determination may be based on various factors, such as the content of the user's message, the current context of the development environment, and/or predefined triggers associated with certain types of requests. In some cases, the platform 102 may employ natural language processing techniques to analyze the user's input and identify the most appropriate agent to handle the task.

At 506, if it is determined that no special agent is needed, the process 500 proceeds to 508 where a generic chat agent is selected. This generic chat agent may be capable of handling a wide range of general queries and providing basic assistance. In some implementations, the generic chat agent may utilize a large language model (LLM) to generate responses based on the user's input and the current context.

Additionally, or alternatively, at 506, if it is determined that a special agent is needed, the process 500 may proceed to step 510, where the platform 102 picks an agent that is needed based on the specific requirements of the task. For example, the platform 102 may select a bug fixing agent, a code repair agent, a context indexing agent, a continuous integration and continuous delivery (CI/CD) agent, an onboarding agent, a code review agent, a UI generation agent, a database management agent, a documentation agent, a testing agent, a security review agent, a refactoring agent, a migration agent, an environment management agent, and/or a custom agent designed for particular tasks. In some cases, the selection of the agent may be based on predefined rules or machine learning algorithms that match the user's request to the most suitable agent type.

After selecting an agent, the process 500 may include another decision point 512, where it is determined if additional input is needed. This ensures that the selected agent has all the necessary information to perform its task effectively. In examples where additional input is needed, the process 500 may take different paths depending on the type of input required. In some examples, additional input may be needed from the agent and/or from the user. For example, if input from the agent is needed at 512, the process 500 may return to step 510 where additional input from the agent is received. This may involve the agent querying internal databases, analyzing the codebase, or performing preliminary computations to gather the required information. In some implementations, the agent may also interact with other components of the code generation platform 102, such as the context indexer 136(1) or the code repair tool 136(3), to obtain relevant data.

Additionally, or alternatively, at 512, if additional input from the user is needed, the process 500 may leverage the generic chat agent at step 508 to receive the input from the user. This approach allows for a seamless interaction where the platform 102 can ask follow-up questions or request clarifications from the user in a conversational manner. The generic chat agent may be designed to ask targeted questions based on the specific information needed by the special agent to complete its task.

Additionally, or alternatively, at 512, if no additional input is needed, or after receiving the necessary input, the process 500 may proceed to 514, where an agentic action is performed. At this step, the selected agent executes its primary function, which may include generating code, fixing bugs, indexing context, or performing custom actions as defined by the user or the platform 102. During this step, the agent may request and receive any contexts, integrations, tools, and/or any other information that is required to perform the action effectively. For example, if the selected agent is a code generation agent, it may query the context indexing component 136(1) to obtain relevant project information, analyze existing code structures, and generate new code that fits seamlessly into the current project. If the agent is a bug fixing agent, it may analyze diagnostics data, generate patches, and apply fixes to the codebase. The agent may also plan several actions before executing them sequentially, or perform a search (e.g., using a Monte Carlo Tree Search) to determine the best next action.

Following the agentic action, the process 500 may include another decision point 516 to determine if the agent task is finished. This ensures that all necessary actions have been completed and the user's request has been fully addressed. At 516, if the task is not finished, the process 500 may return to 512 to check if additional input is needed to continue or complete the task. This creates a loop that allows for iterative refinement and multi-step processes when handling complex requests. Additionally, or alternatively, at 516, if the task is finished, the process 500 may include another decision point 518 to determine if another agent was called during the process 500. This check may account for scenarios where the initial agent may have required assistance from or handed off tasks to other specialized agents. At 518, if another agent was called, the process 500 returns data to the initial agent, allowing for the integration of results from multiple agents. Additionally, or alternatively, at 518, if no other agent was called, or after integrating results from other agents, the process 500 returns an answer to the user. This answer may include generated code, bug fixes, analysis results, or any other output relevant to the user's initial request.

Throughout this process 500, the call agent 136(2) tool plays a crucial role in managing the flow of information and actions between different components of the code generation platform 102. For example, the call agent tool 136(2) may handle the selection and invocation of appropriate agents, manage the exchange of data between agents and other platform components, and ensure that the user receives a coherent and useful response to their query.

As described herein, the agentic chat process 500 of the code generation platform 102 may be enhanced with capabilities that leverage contextual information, user action logging, and/or environmental awareness to improve code generation and assistance. In some examples, the process 500 may include accessing the context of what the user is currently working on, such as bug tickets or feature specifications. This contextual awareness may allow the platform 102 to provide more relevant and targeted assistance during code generation sessions.

In some examples, the code generation platform 102 may maintain a log of meaningful actions that the user performs, along with the results of those actions. This action log may be utilized by the agentic chat to understand the user's workflow and provide more accurate suggestions or solutions. For example, if a user has recently executed a build command that resulted in a compiler error, the agentic chat may take this information into account when generating code or providing assistance. The platform 102 may also have access to information about the user's environment. This environmental awareness may include details about the environment management tools being used, which libraries are installed, and which build tools and compilers are being utilized. In some examples, this information may be gathered by the context indexer 136(1) and stored as part of the indexed context information in the database 142. By leveraging this comprehensive contextual information, the agentic chat process 500 may generate more accurate and relevant code. For instance, if the platform 102 is aware that a specific library is installed in the user's environment, it may suggest code snippets or solutions that utilize that library. Similarly, if the platform 102 knows which compiler is being used, it may tailor its code generation to avoid known issues or take advantage of specific compiler features.

Additionally, or alternatively, the agentic chat process 500 may use the contextual information to provide more than just code generation. It may offer suggestions for debugging based on recent user actions and their results, recommend optimizations based on the specific build tools being used, or provide guidance on best practices for the particular development environment. Additionally, or alternatively, it may get explicit information and/or infer implicit information about the user-desired goal (e.g., such as fixing an issue documented in a JIRA ticket).

The agentic chat process 500 may also be capable of generating commands for the environment, such as suggesting the installation of a new library or proposing changes to build configurations. This capability may extend the system's assistance beyond just code generation to encompass a broader range of software development tasks.

By combining these enhanced capabilities, the agentic chat process 500 of the code generation platform 102 may provide a more holistic and context-aware assistance to users, potentially improving productivity and code quality across various stages of the software development process.

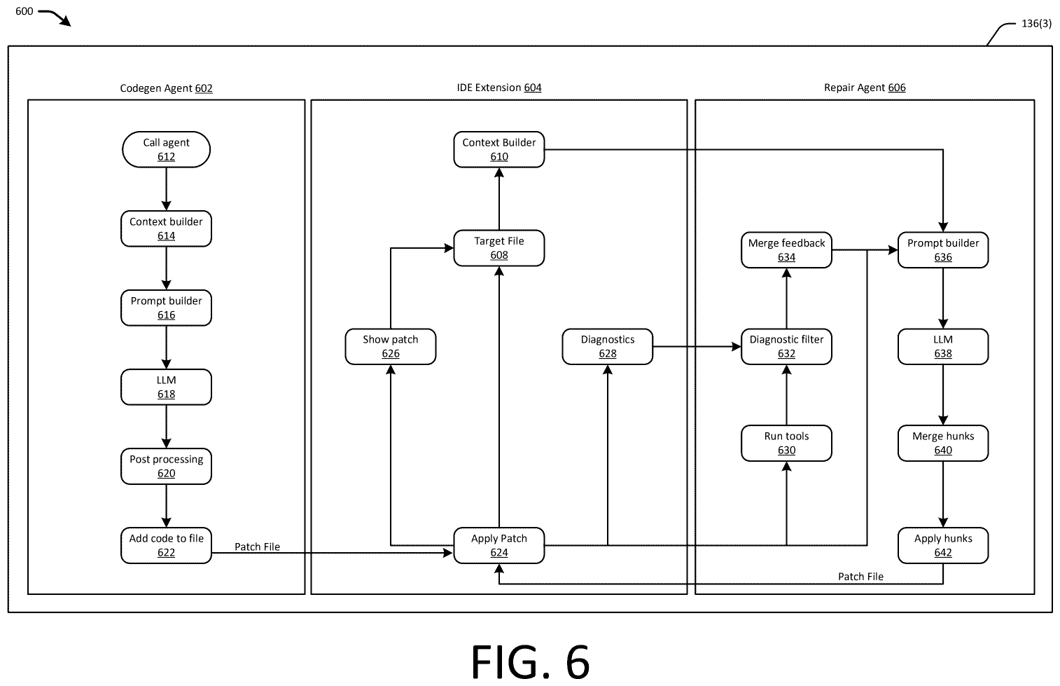

FIG. 6 illustrates a flow diagram 600 for repairing and optimizing computer code using a code repair tool 136(3) of the platform 102. In some examples, the code repair tool 136(3) may include various components, such as, for example, a code generation agent 602 (also referred to herein as a codegen agent), an IDE extension 604, and/or a repair agent 606. These components may work together to analyze, modify, and improve existing code through an iterative process.

The flow diagram 600 may begin with a target file 608, which may serve as input to a context builder 610. In some cases, the target file 608 may contain code that requires repair or optimization. The context builder 610 may analyze the target file 608 to gather relevant information about the code structure, dependencies, and potential issues.

At 612, the codegen agent 602 may receive a request to call an agent, which initiates a code generation process. At 614, the called agent may leverage a context builder to determine context associated with calling the agent. At 616, the context determined from the context builder may be fed into a prompt builder to provide an input to a LLM (Large Language Model) 618. The LLM 618 may generate new or modified code based on the provided context and prompts. At 620, the output from the LLM 618 may undergo post processing. Then, at 622, after the post processing, the code may be added to the file 622.

The IDE extension 604 may serve as an intermediary between the codegen agent 602 and the repair agent 606. In some cases, it may leverage the context builder 610 that receives input from the target file 608. The IDE extension 604 may also include components for showing a patch 626 associated with the target file 608 and applying a patch 624 to the target file 608. A diagnostics component 628 within the IDE extension 604 may provide feedback to the repair agent 606.

The repair agent 606 may contain several components that work together to refine and apply code changes. In some examples, a diagnostics component 628 may gather diagnostics data indicative of errors within the code and/or various analytical tools 630 may be ran on the code to determine errors within the code. For example, the diagnostics component 628 may gather diagnostics data representing first feedback data indicative of first errors within the code. Additionally, or alternatively, one or more analytical tools 630 may be run on the target file 608 to generate second feedback data indicative of second errors within the code. The first feedback data and/or the second feedback data may be fed into a diagnostics filter 632. The diagnostics filter 632 may output first filtered feedback data and/or second filtered feedback data. Filtered feedback data may represent the errors in the code sorted by the type of error. At 634, the first feedback and/or the second feedback may be merged to generate merged feedback data. This merged feedback data may include a merged representation of the first errors in the code and the second errors in the code. The merged feedback may be fed into a prompt builder 636 to format the data to be input into another LLM 638. The output from this LLM 638 may be processed and hunks that are output may be merged to generate merged hunks 640. These merged hunks 640 may be applied to the target file 608 by applying a patch 624 to the target file 608.

In some cases, the flow diagram 600 may represent an iterative workflow where code generated by the codegen agent 602 is passed as a patch file to the IDE extension 604. The IDE extension 604 may apply the patch and run diagnostics. If issues are detected, the repair agent 606 may process the feedback, generate corrections, and apply the changes back to the target file 608 through the IDE extension 604. This may allow for an iterative process of code generation, error detection, and correction, utilizing machine learning models and specialized components to enhance code quality and functionality. In some examples, the code repair tool 136(3) may be capable of handling various types of code errors, including syntax errors, logical errors, performance issues, and security vulnerabilities.

As described herein, the codegen agent 602 may be configured to generate patched computer code in some cases. For example, it may identify previous computer code generated in a previous computer code generation session based on attributes of a query or trigger event. The codegen agent 602 may then generate, utilizing the LLM 618, hunks indicative of errors in the previous computer code. These hunks may be used to patch the previous computer code by inserting portions of newly generated code into the previous computer code according to the hunks. In some implementations, the repair agent 606 may generate diagnostics data indicative of errors in the previous computer code. This may be based on the diagnostics component 628 processing the previous computer code and newly generated code. The repair agent 606 may filter the errors indicated by the diagnostics data to produce filtered diagnostics data indicating types of errors in the previous computer code. The LLM 638 may then generate hunks indicative of the errors, with the errors organized within the hunks based on the types of errors indicated by the filtered diagnostics data.

The repair agent 606 may also be capable of merging different types of feedback data. For instance, it may generate first feedback data indicative of first errors using the diagnostics component 628 and second feedback data indicative of second errors using the analytical tools 630. These first and second errors may be merged to create merged feedback data, which may be formatted by a prompt builder 636 to be used as input to the LLM 638 to generate hunks indicative of the merged errors. In some cases, the hunks generated by the repair agent 606 may include first hunks and second hunks. The repair agent 606 may generate patching instructions indicating an order in which to process the hunks when patching the previous computer code. This may involve patching a first portion of the previous computer code utilizing the first hunks, and then patching a second portion of the previous computer code utilizing the second hunks after patching the first portion. Additionally, or alternatively, the code repair tool 136(3) may be configured to generate and repair code associated with graphical user interfaces (GUIs). In such cases, the codegen agent 602 may be configured as a GUI code generation agent, capable of generating or modifying code that defines GUI elements and their properties.

Overall, the flow diagram 600 illustrated in FIG. 6 outlines a sophisticated approach to code repair and optimization, leveraging machine learning models, contextual analysis, and iterative refinement to improve code quality and functionality. This process may significantly enhance developer productivity by automating many aspects of code maintenance and improvement.

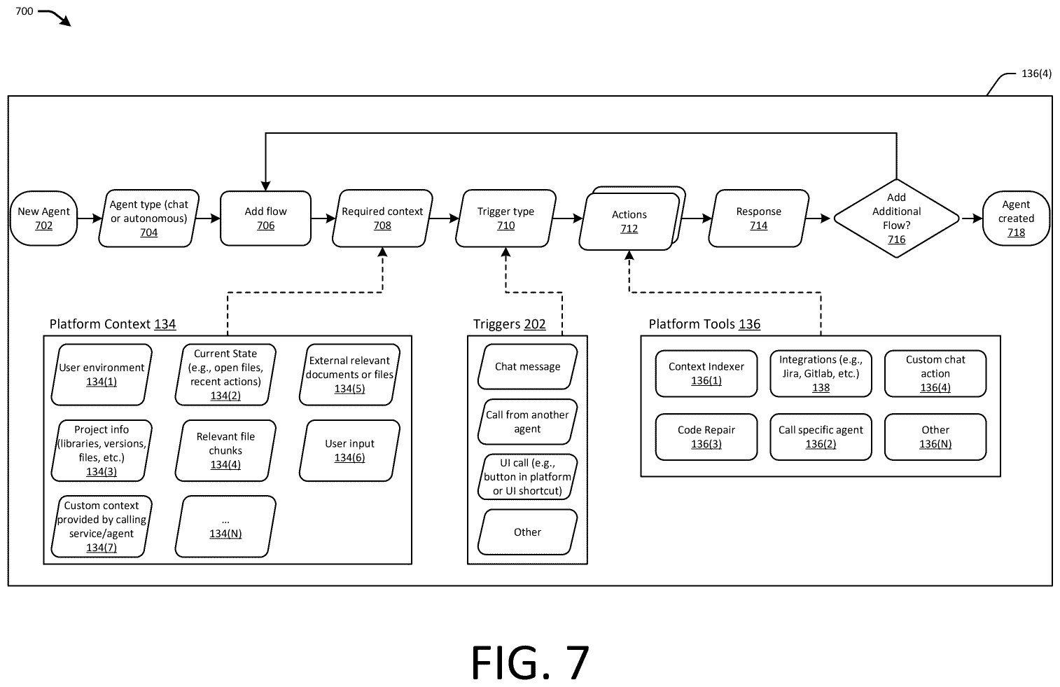

FIG. 7 illustrates a flow diagram of an example process 700 for creating and configuring a new agent using the code generation platform 102. As illustrated, FIG. 7 includes several components and/or process 700 steps for agent creation and configuration.

The process 700 may begin at 702, when a request for a new agent 702 is received (e.g., via a user interface and/or as a call from another agent and/or component of the platform 102), which can be of different agent types, such as, for example, a chat agent and/or an autonomous agent. At 704, the agent type may be determined based on various attributes associated with the request.

At 706, the process 700 may include adding a flow where the configuration of the agent begins. For example, this step may involve initiating a sequence of configuration options for the new agent, such as defining its purpose, behavior, and interaction parameters. At 708, the context required for configuration of the agent may be retrieved. In some examples, the context indexer 136(1) may be leveraged to determine relevant context information, such as existing code repositories, project documentation, or user preferences. This context may help tailor the agent's capabilities to the specific needs of the project or user. At 710, the process 700 may include determining a trigger type. For instance, this step may involve specifying the conditions or events that will activate the agent, such as user commands, scheduled tasks, or specific code changes. The trigger type may be selected from a predefined list or customized based on project requirements.

At 712, the process 700 may include performing various actions. In some examples, at 712, the actions may be performed by leveraging one or more tools 136 and/or integrations 138 offered by the platform 102. These actions may involve tasks such as code generation, bug fixing, or other software development activities. The tools 136 and integrations 138 may provide specialized functionalities that enhance the capabilities of the custom agent being created. For instance, the context indexer 136(1) may be used to gather relevant project information, while the code repair tool 136(3) could be employed for identifying and fixing code issues. External integrations may be utilized like Jira 138(1) for issue tracking or project planning, GitHub 138(2) for version control and workflows, and/or additional external integrations 138(N) may be utilized including project management systems like Asana, CI/CD tools like Jenkins, build tools like Maven, compilers like Javac, static code analysis tools like SonarQube, security analysis tools like Snyk, application performance management tools like Sentry, container tools like Doker, cloud suites like Google Cloud, various commands available through the IDE like VSCode, shells like Bash, file editing tools, and/or unit testing tools like Junit. At 714, the process 700 may include receiving a response regarding the context, trigger, and/or the actions. This response may provide feedback on the configuration choices made for the custom agent, potentially including suggestions for optimization or alerts about potential conflicts. The response may be generated by the platform 102 based on its analysis of the selected agent type, trigger, and actions in relation to the available contexts and tools. This step may allow for iterative refinement of the custom agent's configuration before finalization.

At 716, the process 700 may include a decision to add additional flow(s). In examples where additional flow(s) are to be added, the process 700 may return to 706 to add additional flow step if needed. Additionally, or alternatively, at 716, if it is determined that no additional flow(s) are to be added, the process 700 may proceed to 718, where the agent may be created.

As illustrated, FIG. 7 also depicts components and/or triggers of the platform 102 that provide context and functionality to the agent creation process, such as, for example, platform context 134, platform triggers 202, and/or platform tools 136. The platform context 134 may include several contexts, such as, for example, a user environment 134(1), a current state 134(2) (e.g., which may include open files and recent actions), latest changes and logs, project information 134(3)(containing information about libraries, versions, and/or files), relevant file chunks 134(4), external relevant docs 134(5), user input 134(6), custom context 134(7) provided by calling service/agent and/or additional contexts 134(N). The triggers 202 may outline various ways an agent can be activated, such as, for example, via a chat message, a call from another agent, a UI call (e.g., button in platform or UI shortcut), and/or an other unspecified triggers. The Platform Tools 136 may include the context indexer 136(1) tool, a call agent 136(2) tool, a code repair 136(3) tool, a custom action 136(4) tool, and/or additional tools 136(N).

The process 700 may be configured to create a new agent by configuring its type, required context, triggers, actions, and responses, while utilizing the platform's context, triggers, and tools to enhance its functionality. In some examples, the process 700 may allow users to define custom agents as commands to be performed by an agent. For example, a user may define a custom agent to automatically generate code for a specific type of GUI element whenever a certain trigger event occurs. The user may specify the agent type (e.g., GUI code generation), the trigger event (e.g., creation of a new project file), and the action to be performed (e.g., generate boilerplate code for a button). Additionally, or alternatively, the process 700 may include steps for associating the custom computer code generation agent with metadata indicating attributes of the agent. This metadata may represent features of the custom agent, which can be used to enable sharing and discovery of agents between users. For instance, a user may create a custom agent for optimizing database queries, and associate it with metadata tags such as “database”, “optimization”, and “SQL”. As described above, the platform 102 may allow users to request access to already-generated custom agents created by other users. The platform 102 may parse a database of custom agents using features or attributes identified in the request to locate relevant agents. Once identified, the platform 102 may enable access to these custom agents for the requesting user, facilitating knowledge sharing and collaboration within the development community.

Additionally, or alternatively, a user interface for creating custom agents may include elements for selecting between different agent types, such as chat-based agents that run when explicitly called by the user, or autonomous agents that operate in the background without direct user input. The platform 102 may generate script representing the custom agent based on these selections, tailoring the agent's behavior to the user's specific needs.

Additionally, or alternatively, the process 700 may support the creation of custom agents capable of performing sequential code generation tasks. Users may input data indicating a series of code generation steps to be performed in a specific order, and the platform 102 may generate script that enables the custom agent to execute these tasks sequentially. In some examples, the custom agent creation process 700 may allow users to link multiple agents together. For example, a user may create a custom agent for generating GUI code and link it to another agent specialized in code repair. The platform 102 may generate a link between these agents, allowing the GUI code generation agent to automatically invoke the repair agent after generating initial code. Such agents might then be executed once or in a batch mode (e.g., sequentially or in parallel), allowing the ability to process large scale tasks, such as code migrations. The agent can also be called multiple times to compare the results (e.g., manually, automatically, and/or with the help of another agent) and select the best one, thus improving the quality of the code and the intelligence of the AI system.

The process 700 for creating and configuring custom agents may enhance the flexibility and power of the code generation platform 102, allowing users to tailor the system's capabilities to their specific development needs and workflows.

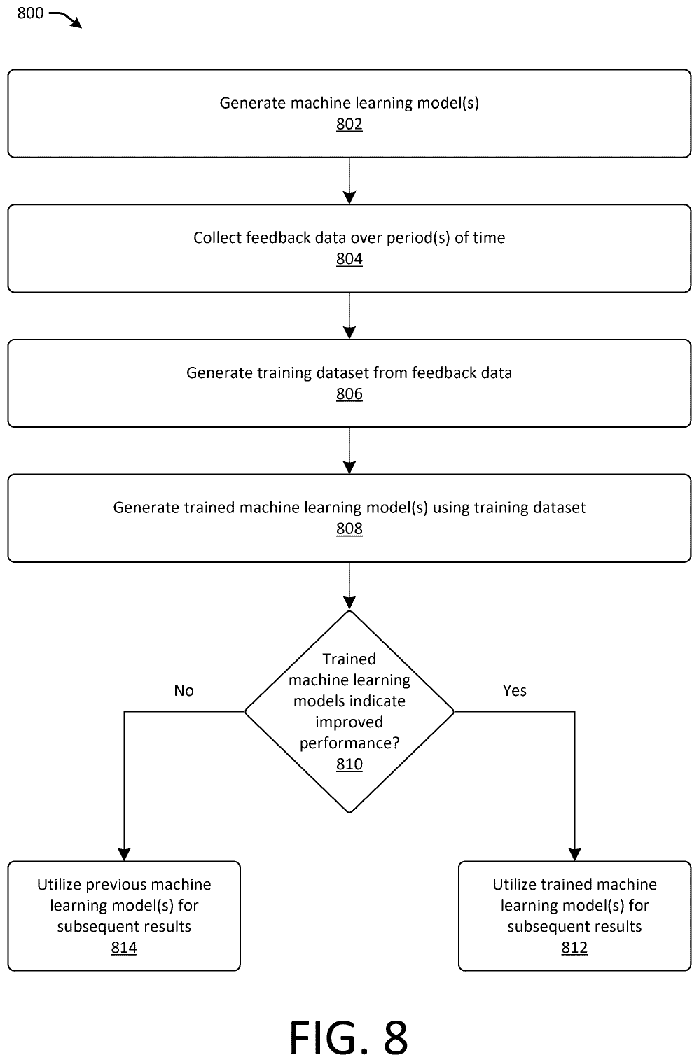

FIGS. 8-26 and 28-32 illustrate processes 800-2600 and 2800-3200 for the platform described herein. The processes 800-2600 and 2800-3200 described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes 800-2600 and 2800-3200 are described with reference to the environments, architectures and systems described in the examples herein, such as, for example those described with respect to FIGS. 1-7 and 27, although the processes 800-2600 and 2800-3200 may be implemented in a wide variety of other environments, architectures and systems.

FIG. 8 is a flow diagram of an example process 800 for the generation and training of artificial intelligence models (also referred to herein as machine learning models) to perform one or more of the processes described herein, according to an example described herein. The order in which the operations or steps are described is not intended to be construed as a limitation, and any number of the described operations may be combined in any order and/or in parallel to implement process 800.

At block 802, the process 800 may include generating one or more artificial intelligence models, such as a machine learning model. A number of artificial intelligence techniques may be employed to generate and/or modify the layers and/or models described herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based artificial intelligence.

At block 804, the process 800 may include collecting feedback data over a period of time. The feedback data may include any data associated with determining questions and/or activities to present to a user, any described with respect to FIGS. 1-7, or any other data that may be utilized to perform the operations described herein. This information may include, for example, user input data, user activity data, etc.

At block 806, the process 800 may include generating a training dataset from the feedback data. Generation of the training dataset may include formatting the feedback data into input vectors for the artificial intelligence model to intake, as well as associating the various data with the outcomes of the questions and/or activities described herein.

At block 808, the process 800 may include generating one or more trained artificial intelligence models utilizing the training dataset. Generation of the trained artificial intelligence models may include updating parameters and/or weightings and/or thresholds utilized by the models to determine appropriate questions to present to the user, appropriate activities to recommend, and the like.

At block 810, the process 800 may include determining whether the trained artificial intelligence models indicate improved performance metrics. For example, a testing group may be generated where the outcomes of given questions and/or activities are known but not to the trained artificial intelligence models. The trained artificial intelligence models may generate results, which may be compared to the known results to determine whether the results of the trained artificial intelligence model produce a superior result than the results of the artificial intelligence model prior to training.

In examples where the trained artificial intelligence models indicate improved performance metrics, the process 800 may include, at block 812, utilizing the trained artificial intelligence models for generating subsequent results. For example, the trained artificial intelligence models may be utilized to determine appropriate questions to present to the user, appropriate activities to recommend, appropriate account balances to be maintained, and/or the like. It should be understood that the trained artificial intelligence models may be utilized in any scenario where models are utilized as described herein.

In examples where the trained artificial intelligence models do not indicate improved performance metrics, the process 800 may include, at block 814, utilizing the previous iteration of the artificial intelligence models for generating subsequent results.

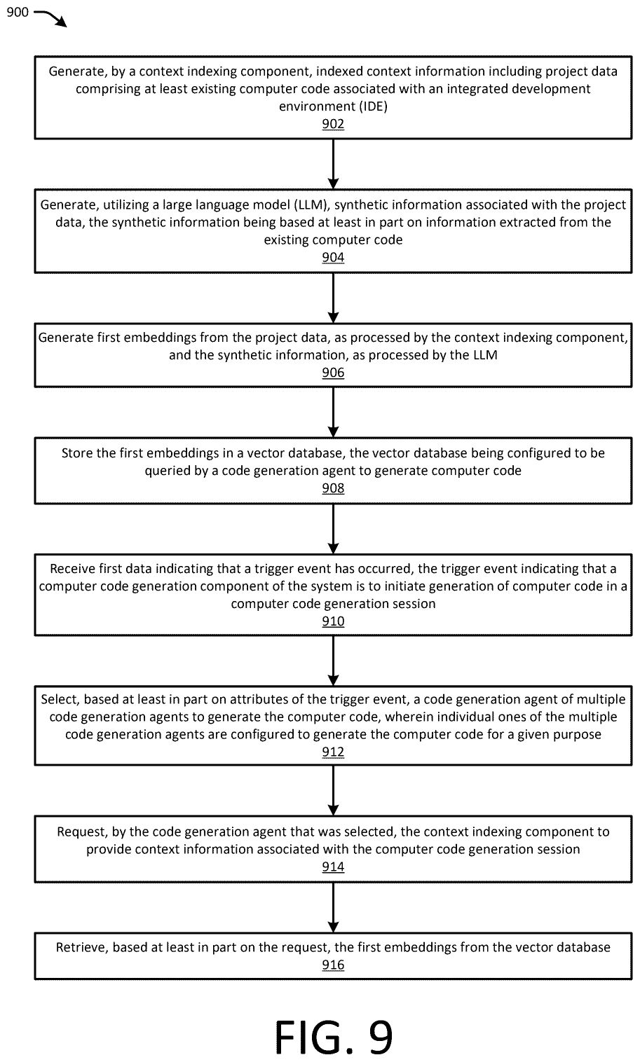

Referring to FIG. 9, a flow diagram of an example process 900 for performing context indexing and generating embeddings used to generate computer code is illustrated. In some examples, the process 900 may be performed by one or more components and/or services offered by the code generation platform 102, as described with respect to FIGS. 1 and 2.

At 902, the process 900 may include generating, by a context indexing component, indexed context information including project data comprising at least existing computer code associated with an integrated development environment (IDE).

At 904, the process 900 may include generating, utilizing a large language model (LLM), synthetic information associated with the project data, the synthetic information being based at least in part on information extracted from the existing computer code.

At 906, the process 900 may include generating first embeddings from the project data, as processed by the context indexing component, and the synthetic information, as processed by the LLM.

At 908, the process 900 may include storing the first embeddings in a vector database, the vector database being configured to be queried by a code generation agent to generate computer code.

At 910, the process 900 may include receiving first data indicating that a trigger event has occurred, the trigger event indicating that a computer code generation component of the system is to initiate generation of computer code in a computer code generation session.

At 912, the process 900 may include selecting, based at least in part on attributes of the trigger event, a code generation agent of multiple code generation agents to generate the computer code, wherein individual ones of the multiple code generation agents are configured to generate the computer code for a given purpose.

At 914, the process 900 may include requesting, by the code generation agent that was selected, the context indexing component to provide context information associated with the computer code generation session.

At 916, the process 900 may include retrieving, based at least in part on the request, the first embeddings from the vector database.

Additionally, or alternatively, the process 900 may include generating environmental data associated with the computer code generation session. In some examples, the environmental data may comprise at least library information indicating one or more libraries installed on a user device associated with the user account, operating system information indicating details of an operating system utilized by the user account, and/or database information indicating details of one or more databases utilized by the user account. Additionally, or alternatively, the process 900 may include generating second embeddings from this environmental data as processed by the context indexing component and storing these second embeddings in the vector database.

Additionally, or alternatively, the process 900 may include identifying files associated with the user account and determining, from the file structure data, a file structure of the files. In some examples, the file structure may indicate associations between the files in the file structure and a hierarchy of the files in the file structure. The process 900 may include generating a hierarchal summarization of the file structure, generating second embeddings from this hierarchal summarization, and storing these second embeddings in the vector database.

Additionally, or alternatively, the process 900 may include generating, by the context indexing component, indexed external data. In some examples, the indexed external data may include at least external documents that are not specific to the user account, languages and frameworks specifications, security vulnerability database information, and related public documents. The process 900 may include generating second embeddings from the indexed external data as processed by the context indexing component and storing these second embeddings in the vector database. In some cases, the second embeddings may indicate a difference between the indexed external data and the indexed context information.

Additionally, or alternatively, the indexed context information may further comprise at least one of text data associated with the user account, file structure data associated with the user account, open file information associated with the user account, and project documentation associated with the computer code generation session.

Additionally, or alternatively, the process 900 may include generating, by the context indexing component, usage data associated with the existing computer code. In some examples, the usage data may indicate, for individual portions of the existing computer code, locations in the IDE where the individual portions of the existing computer code are utilized. The process 900 may include generating the synthetic information further based at least in part on the usage data.

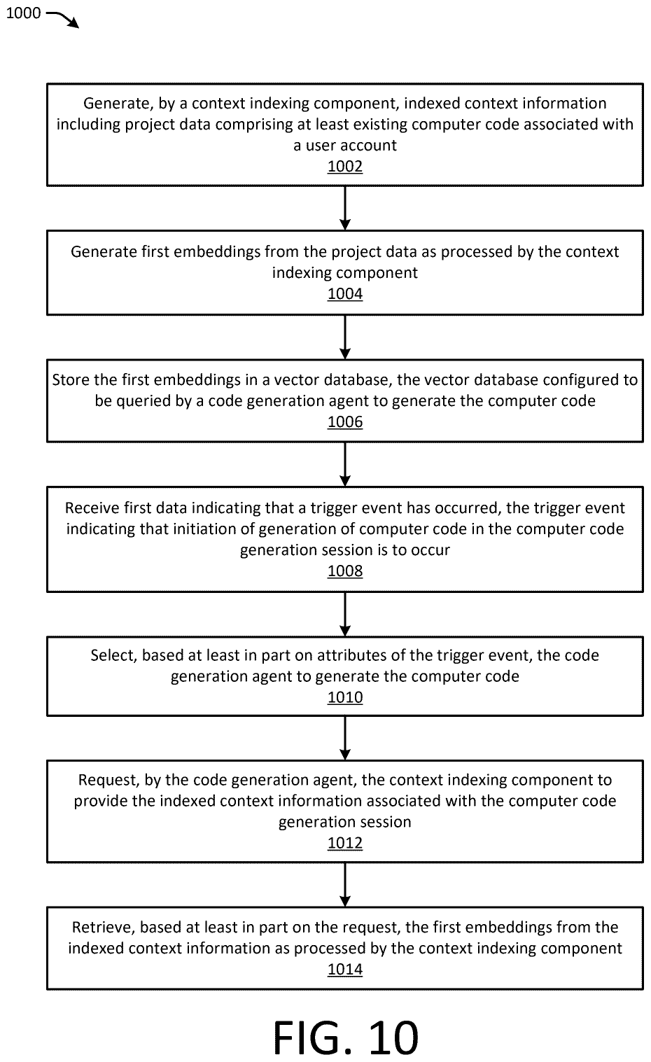

Referring to FIG. 10, a flow diagram of an example process 1000 for performing context indexing and generating embeddings used to generate computer code is illustrated. In some examples, the process 1000 may be performed by one or more components and/or services offered by the code generation platform 102, as described with respect to FIGS. 1 and 2.

At 1002, the process 1000 may include generating, by a context indexing component, indexed context information including project data comprising at least existing computer code associated with a user account.

At 1004, the process 1000 may include generating first embeddings from the project data as processed by the context indexing component.

At 1006, the process 1000 may include storing the first embeddings in a vector database, the vector database configured to be queried by a code generation agent to generate the computer code.

At 1008, the process 1000 may include receiving first data indicating that a trigger event has occurred, the trigger event indicating that initiation of generation of computer code in the computer code generation session is to occur.

At 1010, the process 1000 may include selecting, based at least in part on attributes of the trigger event, the code generation agent to generate the computer code.

At 1012, the process 1000 may include requesting, by the code generation agent, the context indexing component to provide the indexed context information associated with the computer code generation session.

At 1014, the process 1000 may include retrieving, based at least in part on the request, the first embeddings from the indexed context information as processed by the context indexing component.

Additionally, or alternatively, the process 1000 may include generating environmental data associated with the computer code generation session. In some examples, the environmental data may comprise at least library information indicating one or more libraries installed on a user device associated with the user account, operating system information indicating details of an operating system utilized by the user account, and/or database information indicating details of one or more databases utilized by the user account. Additionally, or alternatively, the process 1000 may include generating second embeddings from this environmental data as processed by the context indexing component and storing these second embeddings in the vector database.

Additionally, or alternatively, the process 1000 may include identifying files associated with the user account and/or determining, from the file structure data, a file structure of the files. In some examples, the file structure may indicate associations between the files in the file structure and a hierarchy of the files in the file structure. Additionally, or alternatively, the process 1000 may include generating a hierarchal summarization of the file structure, generating second embeddings from this hierarchal summarization, and storing these second embeddings in the vector database.

Additionally, or alternatively, the process 1000 may include requesting, by the code generation agent that was selected, the context indexing component to provide indexed external data. Additionally, or alternatively, the process 1000 may include generating, by the context indexing component, the indexed external data to include at least plugin documentation, external documents that are not specific to the user account, languages and frameworks specifications, security vulnerability database information, and/or related public documents. Additionally, or alternatively, the process 1000 may include generating second embeddings from the indexed external data as processed by the context indexing component. Additionally, or alternatively, the process 1000 may include storing the second embeddings in the vector database, the second embeddings indicating a difference between the indexed external data and the indexed context information.

Additionally, or alternatively, the process 1000 may include generating the indexed context information according to a first indexing schema based at least in part on the code generation agent that was selected. In some cases, a second indexing schema that differs from the first indexing schema may be utilized when a different code generation agent is selected.

In some examples, generating the indexed context information may be performed prior to receiving the first data indicating the trigger event. Additionally, or alternatively, the process 1000 may further include selecting a subset of the first embeddings to utilize for the computer code generation session based at least in part on the trigger event.

In some examples, the trigger event may comprise receiving a request for code generation. Additionally, or alternatively, the process 1000 may further include generating the indexed context information according to a first indexing schema based at least in part on attributes of the request. In some examples, the indexed context information may be generated according to a second indexing schema when other request attributes are identified.

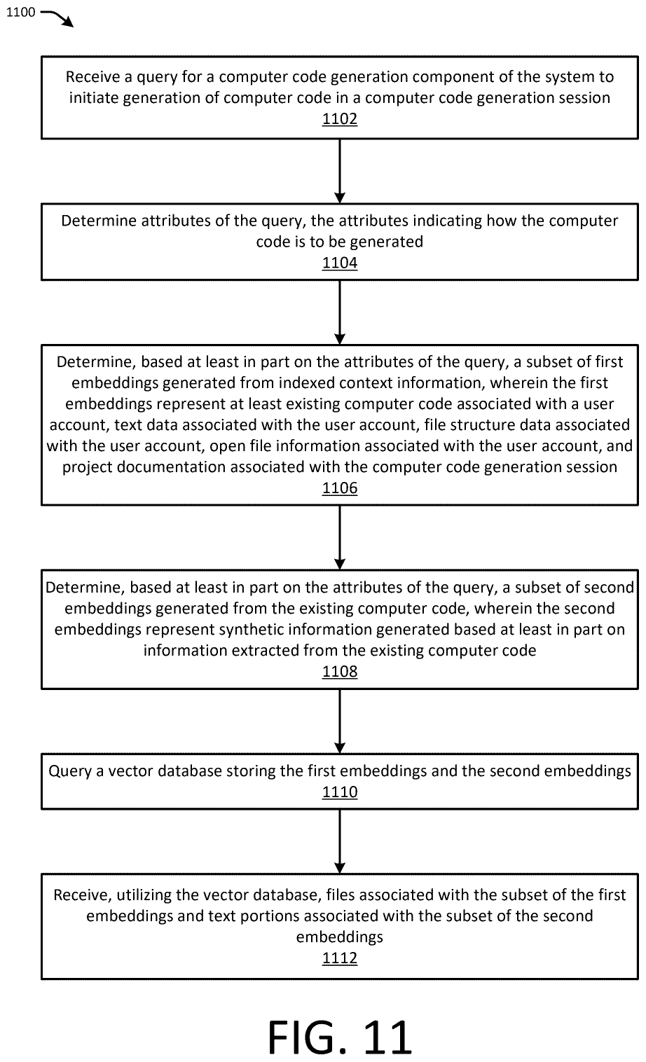

FIG. 11 illustrates a flow diagram of an example process 1100 for retrieving relevant embeddings from different data sources to support code generation. In some examples, the process 1100 may be performed by one or more components and/or services offered by the code generation platform 102, as described with respect to FIGS. 1 and 2.

At 1102, the process 1100 may include receiving a query for a computer code generation component to initiate generation of computer code in a computer code generation session. In some examples, the computer code may be configured to be utilized by computing components of other systems and/or other devices.

At 1104, the process 1100 may include determining attributes of the query. In some cases, these attributes may indicate how the computer code is to be generated. In some examples, the attributes may encompass various aspects such as the programming language, specific libraries or frameworks to be used, or particular coding standards to be followed.

At 1106, the process 1100 may include determining, based at least in part on the attributes of the query, a subset of first embeddings generated from indexed context information. In some examples, the first embeddings may represent at least existing computer code associated with the user account, text data associated with the user account, file structure data associated with the user account, open file information associated with the user account, and/or project documentation associated with the computer code generation session. In some examples, determining the subset of first embeddings generated from the indexed context information may involve analyzing the query attributes to identify which context information is most relevant to the code generation task at hand.

At 1108, the process 1100 may include determining, based at least in part on the attributes of the query, a subset of second embeddings generated from the existing computer code, wherein the second embeddings represent synthetic information generated based at least in part on information extracted from the existing computer code. In some examples, determining the subset of second embeddings may involve analyzing the user's specific context to identify the most relevant information for the code generation task.

At 1110, the process 1100 may include querying a vector database storing the first embeddings and the second embeddings. In some examples, this vector database may be optimized for efficient retrieval of embeddings based on similarity measures.

At 1112, the process 1100 may include receiving, utilizing the vector database, files associated with the subset of the first embeddings and text portions associated with the subset of the second embeddings. In some examples, receiving the files associated with the subset of the first embeddings may involve retrieving the actual content or references to the content that is most relevant to the code generation task based on the determined subsets of embeddings.

Additionally, or alternatively, the process 1100 may include generating a search embedding of the query, the search embedding representing a vector of the query. Additionally, or alternatively, the process 1100 may include comparing the search embedding with embeddings in the vector database to determine which of the embeddings most closely correspond to the search embedding. In these examples, determining the subset of the first embeddings and/or the subset of the second embeddings may be based at least in part on which of the embeddings most closely correspond to the search embedding. This approach may allow for more nuanced matching between the query and the available embeddings.

In some examples, the process 1100 may include determining a query type of the query. The query type may influence how the system interprets and processes the query. In some examples, determining the subset of the first embeddings and/or the subset of the second embeddings may be based at least in part on the query type of the query. This approach may allow the system to tailor its embedding selection based on whether the query is, for example, a request for new code generation, code modification, or bug fixing.

Additionally, or alternatively, the process 1100 may include determining a type of code generation agent selected to generate the computer code in response to the query. In some examples, different types of code generation agents may be specialized for different tasks or programming paradigms. Additionally, or alternatively, determining the subset of the first embeddings and/or the subset of the second embeddings may be based at least in part on the type of the code generation agent. This approach may allow the system to provide the most relevant information to the selected code generation agent, potentially improving the quality and relevance of the generated code.

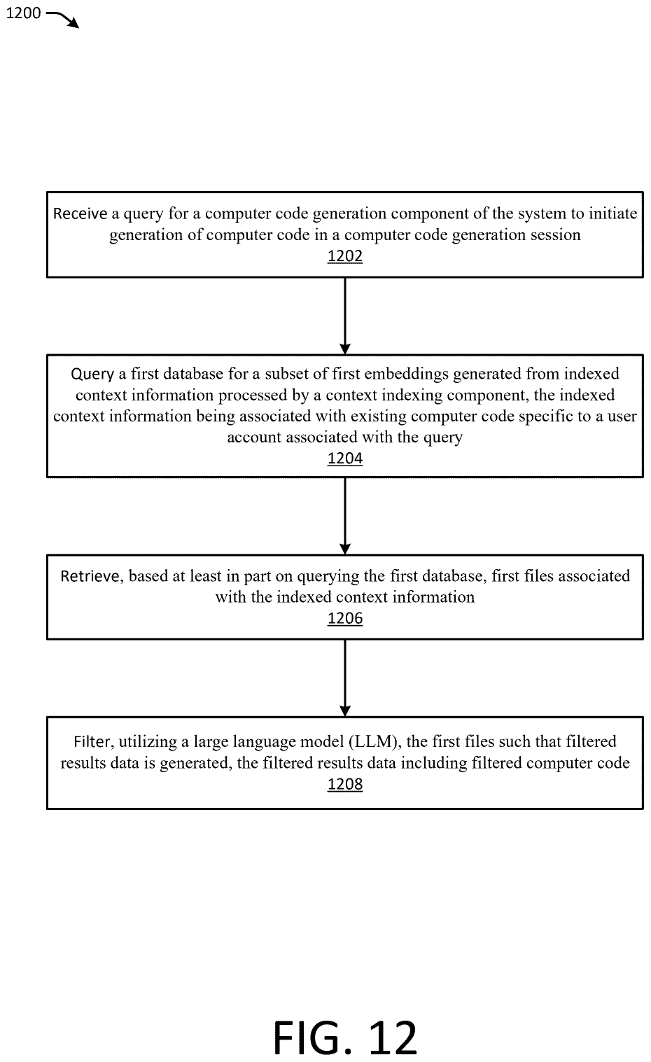

FIG. 12 illustrates a flow diagram of an example process 1200 for retrieving and filtering data from multiple databases to support computer code generation. The process 1200 may leverage different data sources and utilize a large language model to filter the results, enhancing the relevance and quality of the generated code. In some examples, the process 1200 may be performed by one or more components and/or services offered by the code generation platform 102, as described with respect to FIGS. 1 and 2.

At 1202, the process 1200 may include receiving a query for a computer code generation component to initiate generation of computer code in a computer code generation session. In some examples, the computer code may be configured to be utilized by computing components of other systems and/or other devices.

At 1204, the process 1200 may include generating, by a context indexing component, indexed context information associated with a user account, the indexed context information including project data comprising at least existing computer code associated with the user account.

At 1206, the process 1200 may include generating first embeddings from the indexed context information as processed by the context indexing component, the first embeddings being stored in association with a vector database.

At 1208, the process 1200 may include generating, utilizing a large language model (LLM), synthetic information associated with the project data, the synthetic information being based at least in part on information extracted from the existing computer code.

At 1210, the process 1200 may include generating second embeddings from the synthetic information as processed by the context indexing component, the second embeddings being stored in association with the vector database.

At 1212, the process 1200 may include determining, based at least in part on attributes of the query, at least one of a first subset of the first embeddings that are associated with the query or a second subset of the second embeddings that are associated with the query.

At 1214, the process 1200 may include receiving, utilizing the vector database and based at least in part on the first subset of the first embeddings, at least first files associated with the indexed context information.

At 1216, the process 1200 may include retrieving, utilizing the vector database and based at least in part on the second subset of the second embeddings, text portions associated with the synthetic information.

At 1218, the process 1200 may include filtering, utilizing the LLM, the first files such that filtered results data is generated, the filtered results data including filtered computer code.

Additionally, or alternatively, the process 1200 may include selecting, based at least in part on attributes of the query, a code generation agent of multiple code generation agents to generate the computer code, wherein individual ones of the multiple code generation agents are configured to generate the computer code for a given purpose.

Additionally, or alternatively, the process 1200 may include generating, by the context indexing component, environmental data associated with the computer code generation session. In some examples, the environmental data may comprise at least library information indicating one or more libraries installed on a user device associated with the user account, operating system information indicating details of an operating system utilized by the user account, and database information indicating details of one or more databases utilized by the user account. The process 1200 may include generating third embeddings from the environmental data as processed by the context indexing component. Additionally, or alternatively, the process 1200 may further include determining, based at least in part on the attributes of the query, a subset of the third embeddings that are associated with the query. Additionally, or alternatively, the process 1200 may include receiving, utilizing the vector database, at least text data associated with the subset of the third embeddings. The process 1200 may then include filtering, utilizing the LLM, the text data such that the filtered results data includes filtered text data.

Additionally, or alternatively, the process 1200 may include generating, by the context indexing component, indexed company data. In some examples, the indexed company data may represent at least company documents, internal application programming interface documents, custom files associated with the user account, library information indicating one or more libraries installed on a user device associated with the user account, operating system information indicating details of an operating system utilized by the user account, and database information indicating details of one or more databases utilized by the user account. The process 1200 may include generating third embeddings from the indexed company data as processed by the context indexing component. Additionally, or alternatively, the process 1200 may further include determining, based at least in part on the attributes of the query, a subset of the third embeddings that are associated with the query. Additionally, or alternatively, the process 1200 may include receiving, utilizing the vector database, at least second files associated with the subset of the third embeddings. The process 1200 may then include filtering, utilizing the LLM, the second files such that the filtered results data includes filtered company data.

Additionally, or alternatively, the process 1200 may include generating, by the context indexing component, indexed external data. In some examples, the indexed external data may include at least external documents that are not specific to the user account, languages and frameworks specifications, security vulnerability database information, and related public documents. The process 1200 may include generating third embeddings from the indexed external data as processed by the context indexing component. Additionally, or alternatively, the process 1200 may further include determining, based at least in part on the attributes of the query, a subset of the third embeddings that are associated with the query. Additionally, or alternatively, the process 1200 may include receiving, utilizing the vector database, at least second files associated with the subset of the third embeddings. The process 1200 may then include filtering, utilizing the LLM, the second files such that the filtered results data includes filtered external data.

Additionally, or alternatively, the process 1200 may include generating, by the context indexing component, indexed company data and indexed external data. In some examples, the indexed company data may represent at least company documents, internal application programming interface documents, custom files associated with the user account, library information indicating one or more libraries installed on a user device associated with the user account, operating system information indicating details of an operating system utilized by the user account, and database information indicating details of one or more databases utilized by the user account. The indexed external data may include at least external documents that are not specific to the user account, languages and frameworks specifications, security vulnerability database information, and related public documents.

The process 1200 may include generating third embeddings from the indexed company data as processed by the context indexing component and generating fourth embeddings from the indexed external data as processed by the context indexing component. Additionally, or alternatively, the process 1200 may include determining, based at least in part on the attributes of the query, a subset of the third embeddings that are associated with the query and a subset of the fourth embeddings that are associated with the query.

The process 1200 may further include receiving, utilizing the vector database, at least second files associated with the subset of the third embeddings and at least third files associated with the subset of the fourth embeddings. Additionally, or alternatively, the process 1200 may include filtering, utilizing the LLM, the second files and the third files such that the filtered results data includes filtered company data and filtered external data.

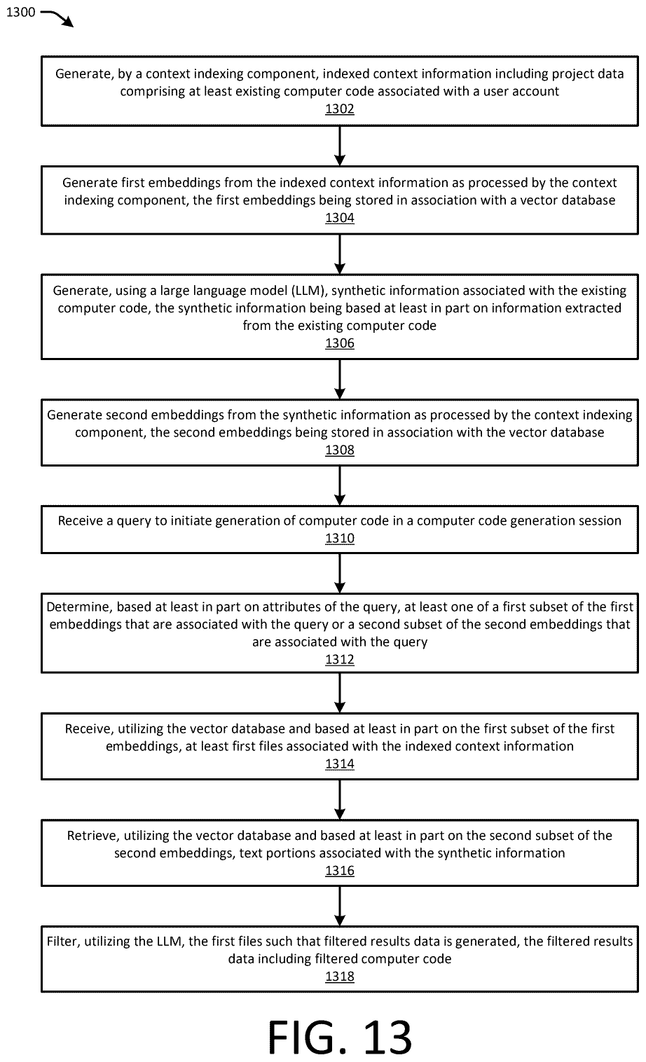

FIG. 13 illustrates a flow diagram of an example process 1300 for generating and filtering context information for computer code generation. The process 1300 may transform indexed context information into embeddings, associate the embeddings with file paths, and filter the information using a large language model to produce relevant context for code generation tasks. In some examples, the process 1300 may be performed by one or more components and/or services offered by the code generation platform 102, as described with respect to FIGS. 1 and 2.

At 1302, the process 1300 may include generating, by a context indexing component, indexed context information including project data comprising at least existing computer code associated with a user account.

At 1304, the process 1300 may include generating first embeddings from the indexed context information as processed by the context indexing component, the first embeddings being stored in association with a vector database.

At 1306, the process 1300 may include generating, using a large language model (LLM), synthetic information associated with the existing computer code, the synthetic information being based at least in part on information extracted from the existing computer code.

At 1308, the process 1300 may include generating second embeddings from the synthetic information as processed by the context indexing component, the second embeddings being stored in association with the vector database.

At 1310, the process 1300 may include receiving a query to initiate generation of computer code in a computer code generation session.

At 1312, the process 1300 may include determining, based at least in part on attributes of the query, at least one of a first subset of the first embeddings that are associated with the query or a second subset of the second embeddings that are associated with the query.

At 1314, the process 1300 may include receiving, utilizing the vector database and based at least in part on the first subset of the first embeddings, at least first files associated with the indexed context information.

At 1316, the process 1300 may include retrieving, utilizing the vector database and based at least in part on the second subset of the second embeddings, text portions associated with the synthetic information.

At 1318, the process 1300 may include filtering, utilizing the LLM, the first files such that filtered results data is generated, the filtered results data including filtered computer code.

Additionally, or alternatively, the process 1300 may include selecting, based at least in part on the attributes of the query, a code generation agent of multiple code generation agents to generate the computer code, wherein individual ones of the multiple code generation agents are configured to generate the computer code for a given purpose.

In some examples, the process 1300 may generating, by the context indexing component, environmental data associated with the computer code generation session, the environmental data comprising at least one of library information indicating one or more libraries installed on a user device associated with the user account, operating system information indicating details of an operating system utilized by the user account, or database information indicating details of one or more databases utilized by the user account. Additionally, or alternatively, the process 1300 may include generating third embeddings from the environmental data as processed by the context indexing component. Additionally, or alternatively, the process 1300 may include determining, based at least in part on the attributes of the query, a subset of the third embeddings that are associated with the query. Additionally, or alternatively, the process 1300 may include receiving, utilizing the vector database, at least text data associated with the subset of the third embeddings. Additionally, or alternatively, the process 1300 may include filtering, utilizing the LLM, the text data such that the filtered results data includes filtered text data.

Additionally, or alternatively, the process 1300 may include generating, by the context indexing component, indexed company data representing at least one of company documents, internal application programming interface documents, custom files associated with the user account at least library information indicating one or more libraries installed on a user device associated with the user account, operating system information indicating details of an operating system utilized by the user account, or database information indicating details of one or more databases utilized by the user account. Additionally, or alternatively, the process 1300 may include generating third embeddings from the indexed company data as processed by the context indexing component. Additionally, or alternatively, the process 1300 may include determining, based at least in part on the attributes of the query, a subset of the third embeddings that are associated with the query. Additionally, or alternatively, the process 1300 may include receiving, utilizing the vector database, at least second files associated with the subset of the third embeddings. Additionally, or alternatively, the process 1300 may include filtering, utilizing the LLM, the second files such that the filtered results data includes filtered company data.

Additionally, or alternatively, the process 1300 may include generating, by the context indexing component, indexed external data including at least external documents that are not specific to the user account, languages and frameworks specifications, security vulnerability database information, and related public documents. Additionally, or alternatively, process 1300 may include generating third embeddings from the indexed external data as processed by the context indexing component. Additionally, or alternatively, the process 1300 may include determining, based at least in part on the attributes of the query, a subset of the third embeddings that are associated with the query. Additionally, or alternatively, the process 1300 may include receiving, utilizing the vector database, at least second files associated with the subset of the third embeddings. Additionally, or alternatively, the process 1300 may include filtering, utilizing the LLM, the second files such that the filtered results data includes filtered external data.

Additionally, or alternatively, the process 1300 may include generating, by the context indexing component, indexed company data representing at least company documents, internal application programming interface documents, custom files associated with the user account at least library information indicating one or more libraries installed on a user device associated with the user account, operating system information indicating details of an operating system utilized by the user account, and database information indicating details of one or more databases utilized by the user account. Additionally, or alternatively, the process 1300 may include generating third embeddings from the indexed company data as processed by the context indexing component. Additionally, or alternatively, the process 1300 may include generating, by the context indexing component, indexed external data including at least external documents that are not specific to the user account, languages and frameworks specifications, security vulnerability database information, and related public documents. Additionally, or alternatively, the process 1300 may include generating fourth embeddings from the indexed external data as processed by the context indexing component. Additionally, or alternatively, the process 1300 may include determining, based at least in part on the attributes of the query, a subset of the third embeddings that are associated with the query. Additionally, or alternatively, the process 1300 may include receiving, utilizing the vector database, at least second files associated with the subset of the third embeddings. Additionally, or alternatively, the process 1300 may include determining, based at least in part on the attributes of the query, a subset of the fourth embeddings that are associated with the query. Additionally, or alternatively, the process 1300 may include receiving, utilizing the vector database, at least third files associated with the subset of the fourth embeddings. Additionally, or alternatively, the process 1300 may include filtering, utilizing the LLM, the second files and the third files such that the filtered results data includes filtered company data and filtered external data.

Additionally, or alternatively, the process 1300 may include determining that a code generation agent selected to generate the computer code is a customized code generation agent specific to the user account. Additionally, or alternatively, the process 1300 may include determining user preferences associated with the customized code generation agent. In some examples, determining at least one of the subset of the first embeddings or the subset of the second embeddings that are associated with the query is based at least in part on the user preferences associated with the customized code generation agent. Additionally, or alternatively, filtering the first files is based at least in part on the user preferences associated with the customized code generation agent.

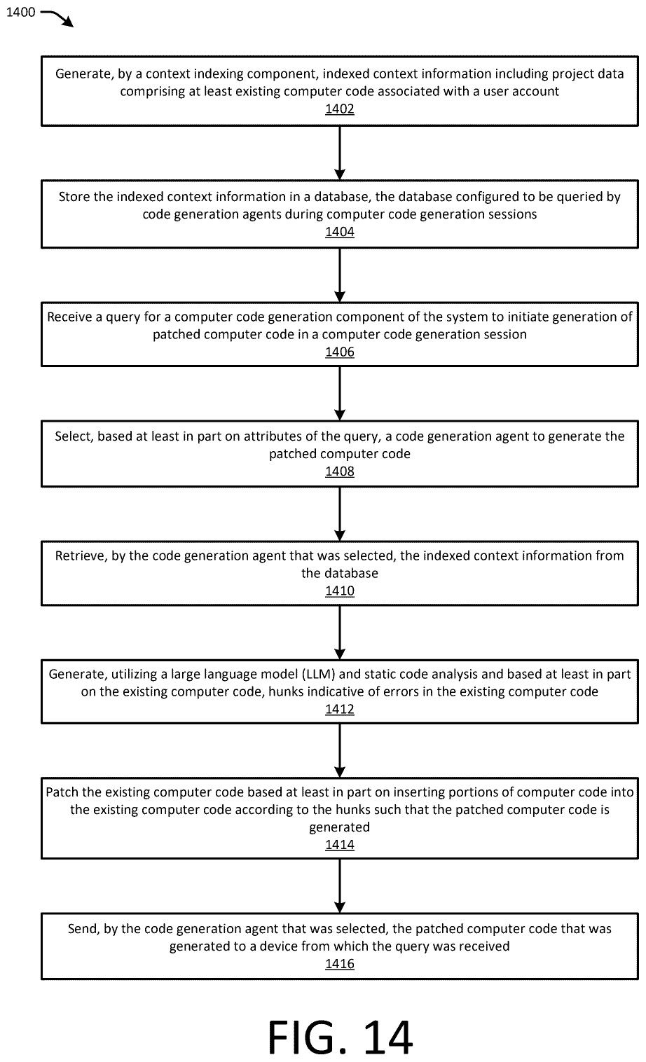

Referring to FIG. 14, a flow diagram of an example process 1400 for generating computer code using a code generation component is illustrated. In some examples, the process 1400 may be performed by one or more components and/or services offered by the code generation platform 102, as described with respect to FIGS. 1 and 2. The process 1400 may focus on how the platform 102 selects an appropriate agent, retrieves indexed context information, and utilizes this context to generate code for a specific purpose.

At 1402, the process 1400 may include generating, by a context indexing component, indexed context information including project data comprising at least existing computer code associated with a user account. In some examples, the context indexing component may correspond to the context indexer 136(1) as described with respect to FIGS. 1-4E.

At 1404, the process 1400 may include storing the indexed context information in a database, the database configured to be queried by code generation agents during computer code generation sessions.

At 1406, the process 1400 may include receiving a query for a computer code generation component of the system to initiate generation of patched computer code in a computer code generation session.

At 1408, the process 1400 may include selecting, based at least in part on attributes of the query, a code generation agent to generate the patched computer code.

At 1410, the process 1400 may include retrieving, by the code generation agent that was selected, the indexed context information from the database.

At 1412, the process 1400 may include generating, utilizing a large language model (LLM) and static code analysis and based at least in part on the existing computer code, hunks indicative of errors in the existing computer code.

At 1414, the process 1400 may include patching the existing computer code based at least in part on inserting portions of computer code into the existing computer code according to the hunks such that the patched computer code is generated.

At 1416, the process 1400 may include sending, by the code generation agent that was selected, the patched computer code that was generated to a device from which the query was received.

Additionally, or alternatively, the process 1400 may include generating, based at least in part on the static code analysis, diagnostics data indicative of the errors in the existing computer code based at least in part on a diagnostics component of the system processing the existing computer code. Additionally, or alternatively, the process 1400 may further include filtering, utilizing the diagnostics component, the errors indicated by the diagnostics data such that filtered diagnostics data is generated, the filtered diagnostics data indicating types of the errors in the existing computer code. Additionally, or alternatively, the errors may be organized within the hunks based at least in part on the types of the errors indicated by the filtered diagnostics data.

In some examples, the types of errors may include at least one of syntax errors, compilation errors, runtime errors, logical errors, resource errors, arithmetic errors, semantic errors and/or interface errors.

Additionally, or alternatively, the process 1400 may include generating first data representative of changes in the patched computer code with respect to the existing computer code. Additionally, or alternatively, the process 1400 may include sending the first data to a device from which the query was received, the first data causing an integrated development environment (IDE) extension to display the changes in the patched computer code on the device.

Additionally, or alternatively, the process 1400 may include receiving, responsive to the first data and from the device, second data representing at least one of an acceptance, a rejection, or a modification associated with the changes in the patched computer code. Additionally, or alternatively, the process 1400 may include based at least in part on the second data, at least one of: patching the existing computer code to generate the patched computer code based at least in part on the acceptance, patching the existing computer code to generate the patched computer code based at least in part on the modification, and/or refraining from generating the patched computer code.

In some examples, the hunks may be first hunks. Additionally, or alternatively, the process 1400 may include generating patching instructions from the hunks as processed by the selected code generation agent, the patching instructions indicating an order in which to process the hunks when patching the existing computer code in the computer code generation session. Additionally, or alternatively, the process 1400 may include patching the existing computer code utilizing the hunks and based at least in part on the patching instructions. In some examples, patching the existing computer code utilizing the hunks may comprise patching a first portion of the existing computer code utilizing the first hunks and/or patching a second portion of the existing computer code utilizing the second hunks after patching the first portion of the existing computer code.

Additionally, or alternatively, the process 1400 may include generating first data representing a toggle element of an integrated development environment (IDE) associated with the user account. In some examples, the toggle may be configured with a first toggle position enabling execution of the generation of the patched computer code without receiving user input indicating approval of the patching of the existing computer code and/or a second toggle position preventing execution of the generation of the patched computer code without receiving the user input indicating the approval of the patching of the existing computer code.

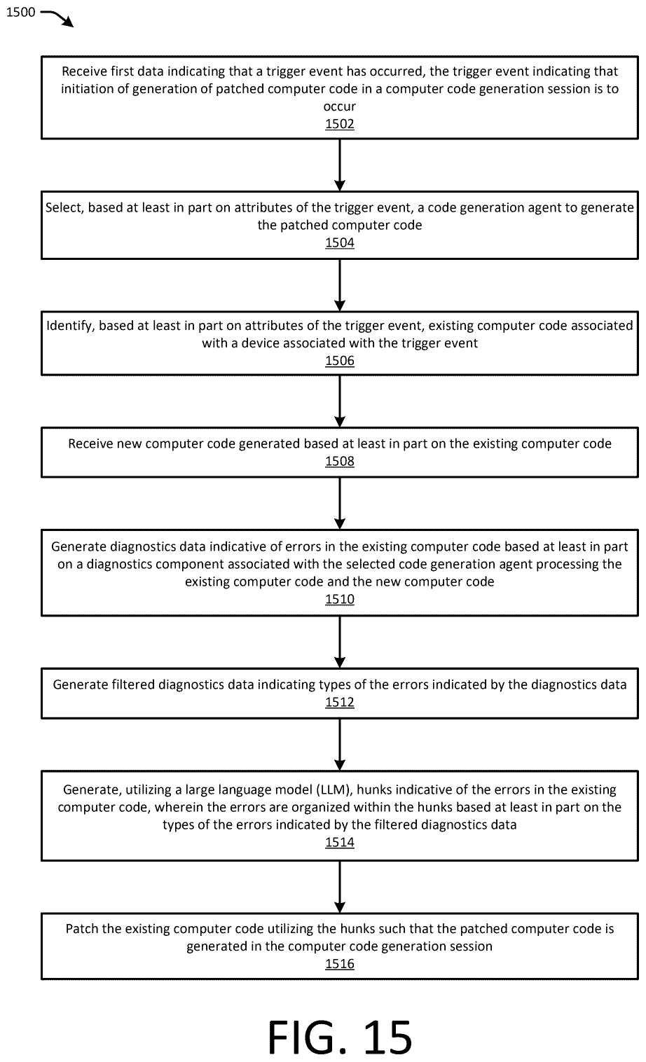

FIG. 15 illustrates a flow diagram of an example process 1500 for generating patched computer code. The process 1500 may leverage a code generation component to initiate the generation of patched computer code in a computer code generation session. In some examples, the patched computer code may be configured to be utilized by computing components of other systems and/or other devices. Additionally, or alternatively, the process 1500 may be performed by one or more components and/or services offered by the code generation platform 102, as described with respect to FIGS. 1 and 2.

At 1502, the process 1500 may include receiving first data indicating that a trigger event has occurred, the trigger event indicating that initiation of generation of patched computer code in a computer code generation session is to occur.

At 1504, the process 1500 may include selecting, based at least in part on attributes of the trigger event, a code generation agent to generate the patched computer code.

At 1506, the process 1500 may include identifying, based at least in part on attributes of the trigger event, existing computer code associated with a device associated with the trigger event.

At 1508, the process 1500 may include receiving new computer code generated based at least in part on the existing computer code.

At 1510, the process 1500 may include generating diagnostics data indicative of errors in the existing computer code based at least in part on a diagnostics component associated with the selected code generation agent processing the existing computer code and the new computer code.

At 1512, the process 1500 may include generating filtered diagnostics data indicating types of the errors indicated by the diagnostics data.

At 1514, the process 1500 may include generating, utilizing a large language model (LLM), hunks indicative of the errors in the existing computer code, wherein the errors are organized within the hunks based at least in part on the types of the errors indicated by the filtered diagnostics data.

At 1516, the process 1500 may include patching the existing computer code utilizing the hunks such that the patched computer code is generated in the computer code generation session.

Additionally, or alternatively, the process 1500 may include generating, by a context indexing component, indexed context information associated with the computer code generation session. Additionally, or alternatively, the process 1500 may include storing the indexed context information in a database, the database configured to be queried by the code generation agent to generate the patched computer code. Additionally, or alternatively, the process 1500 may include retrieving, based at least in part on the code generation agent that was selected querying the database, the indexed context information associated with the computer code generation session. In some examples, generating the patched computer code in the computer code generation session is further based at least in part on the selected code generation agent querying the database.

In some examples, the indexed context information may include various types of data. For example, the indexed context information may include project data associated with the computer code generation session, such as existing computer code associated with a user account, text data associated with the user account, file structure data associated with the user account, open file information associated with the user account, and/or project documentation associated with the computer code generation session. Additionally, or alternatively, the indexed context information may include environmental data associated with the computer code generation session. In some examples, the environmental data may comprise library information indicating one or more libraries installed on a user device associated with the user account, operating system information indicating details of an operating system utilized by the user account, and/or database information indicating details of one or more databases utilized by the user account. Additionally, or alternatively, the indexed context information may include a hierarchal summarization of a file structure of the files based at least in part on the file structure data, with the file structure indicating associations between the files in the file structure and a hierarchy of the files in the file structure. Additionally, or alternatively, the indexed context information may include synthetic information associated with the project data, the synthetic information being based at least in part on information extracted from the existing computer code. In some examples, the indexed context information may further include indexed external data such as plugin documentation, external documents that are not specific to the user account, languages and frameworks specifications, security vulnerability database information, and/or related public documents.

In some examples, the diagnostics data may comprise at least one of first diagnostics data representative of results of static code analysis performed on the existing computer code, second diagnostics data representative of results of a compilation process associated with the existing computer code, and/or third diagnostics data representative of results from tests executed on the existing computer code.

Additionally, or alternatively, the process 1500 may include generating first data representative of changes in the patched computer code with respect to the previous computer code. Additionally, or alternatively, the process 1500 may include sending the first data to a device associated with the trigger event, the first data causing an integrated development environment (IDE) extension to display the changes in the patched computer code on the device.

The process 1500 may include receiving, responsive to the first data and from the device, second data representing at least one of an acceptance, a rejection, or a modification associated with the changes in the patched computer code. Additionally, or alternatively, the process 1500 may include based at least in part on the second data, at least one of patching the existing computer code to generate the patched computer code based at least in part on the acceptance, patching the existing computer code to generate the patched computer code based at least in part on the modification, and/or refraining from generating the patched computer code.

In some examples, the hunks may include first hunks. Additionally, or alternatively, the process 1500 may include generating patching instructions from the hunks as processed by the selected code generation agent, the patching instructions indicating an order in which to process the hunks when patching the previous computer code in the computer code generation session. Additionally, or alternatively, the process 1500 may include patching the previous computer code utilizing the hunks and based at least in part on the patching instructions. In some examples, patching the previous computer code utilizing the hunks may comprise patching a first portion of the previous computer code utilizing the first hunks and/or patching a second portion of the previous computer code utilizing the second hunks after patching the first portion of the previous computer code.

In some examples, the patched computer code is associated with elements of a GUI.

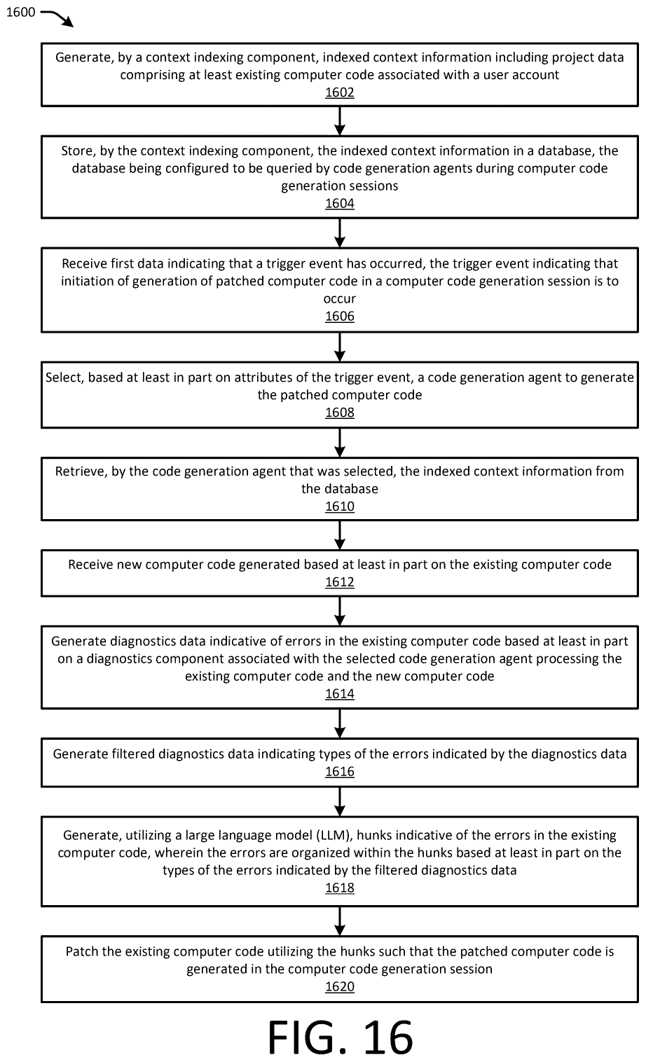

FIG. 16 illustrates a flow diagram of an example process 1600 for generating patched computer code using multiple feedback mechanisms. The process 1600 may leverage different error detection techniques and a large language model to identify and correct errors in computer code. Additionally, or alternatively, the process 1600 may be performed by one or more components and/or services offered by the code generation platform 102, as described with respect to FIGS. 1 and 2.

At 1602, the process 1600 may include generating, by a context indexing component, indexed context information including project data comprising at least existing computer code associated with a user account.

At 1604, the process 1600 may include storing, by the context indexing component, the indexed context information in a database, the database being configured to be queried by code generation agents during computer code generation sessions.

At 1606, the process 1600 may include receiving first data indicating that a trigger event has occurred, the trigger event indicating that initiation of generation of patched computer code in a computer code generation session is to occur.

At 1608, the process 1600 may include selecting, based at least in part on attributes of the trigger event, a code generation agent to generate the patched computer code.

At 1610, the process 1600 may include retrieving, by the code generation agent that was selected, the indexed context information from the database.

At 1612, the process 1600 may include receiving new computer code generated based at least in part on the existing computer code.

At 1614, the process 1600 may include generating diagnostics data indicative of errors in the existing computer code based at least in part on a diagnostics component associated with the selected code generation agent processing the existing computer code and the new computer code.

At 1616, the process 1600 may include generating filtered diagnostics data indicating types of the errors indicated by the diagnostics data.

At 1618, the process 1600 may include generating, utilizing a large language model (LLM), hunks indicative of the errors in the existing computer code, wherein the errors are organized within the hunks based at least in part on the types of the errors indicated by the filtered diagnostics data.

At 1620, the process 1600 may include patching the existing computer code utilizing the hunks such that the patched computer code is generated in the computer code generation session.

Additionally, or alternatively, the process 1600 may include generating, by a context indexing component, indexed context information associated with the computer code generation session. Additionally, or alternatively, the process 1600 may include storing the indexed context information in a database, the database configured to be queried by the code generation agent to generate the patched computer code. Additionally, or alternatively, the process 1600 may include retrieving, based at least in part on the code generation agent that was selected querying the database, the indexed context information associated with the computer code generation session. In some examples, generating the patched computer code in the computer code generation session is further based at least in part on the selected code generation agent querying the database.

In some examples, the indexed context information may include various types of data. For example, the indexed context information may include project data associated with the computer code generation session, such as existing computer code associated with a user account, text data associated with the user account, file structure data associated with the user account, open file information associated with the user account, and/or project documentation associated with the computer code generation session. Additionally, or alternatively, the indexed context information may include environmental data associated with the computer code generation session. The environmental data may comprise library information indicating one or more libraries installed on a user device associated with the user account, operating system information indicating details of an operating system utilized by the user account, and/or database information indicating details of one or more databases utilized by the user account. Additionally, or alternatively, the indexed context information may include a hierarchal summarization of a file structure of the files based at least in part on the file structure data, with the file structure indicating associations between the files in the file structure and a hierarchy of the files in the file structure. Additionally, or alternatively, the indexed context information may include synthetic information associated with the project data, the synthetic information being based at least in part on information extracted from the existing computer code. In some examples, the indexed context information may further include indexed external data such as plugin documentation, external documents that are not specific to the user account, languages and frameworks specifications, security vulnerability database information, and/or related public documents.

In some examples, the diagnostics data is first diagnostics data, the errors are first errors, and/or the diagnostics component is associated with an integrated development environment (IDE) associated with the user account. Additionally, or alternatively, the process 1600 may include receiving second diagnostics data from one or more sources external to the IDE, the second diagnostics data indicative of second errors in the existing computer code. Additionally, or alternatively, the process 1600 may include merging the first errors indicated by the first diagnostics data with the second errors indicated by the second diagnostics data such that merged diagnostics data is generated, the merged diagnostics data including merged errors in the existing computer code. Additionally, or alternatively, the process 1600 may include generating filtered merged diagnostics data indicating types of the merged errors indicated by the merged diagnostics data. Additionally, or alternatively, the process 1600 may include generating, utilizing the LLM, additional hunks indicative of the merged errors in the existing computer code. Additionally, or alternatively, the process 1600 may include patching the existing computer code utilizing the additional hunks such that the patched computer code is generated in the computer code generation session.

Additionally, or alternatively, the process 1600 may include generating first data representative of changes in the patched computer code with respect to the previous computer code. Additionally, or alternatively, the process 1600 may include sending the first data to a device associated with the trigger event, the first data causing an integrated development environment (IDE) extension to display the changes in the patched computer code on the device.

Additionally, or alternatively, the process 1600 may include receiving, responsive to the first data and from the device, second data representing at least one of an acceptance, a rejection, or a modification associated with the changes in the patched computer code. Additionally, or alternatively, the process 1600 may include, based at least in part on the second data, at least one of patching the existing computer code to generate the patched computer code based at least in part on the acceptance, patching the existing computer code to generate the patched computer code based at least in part on the modification, and/or refraining from generating the patched computer code.

In some examples, the hunks may include first hunks and second hunks. Additionally, or alternatively, the process 1600 may include generating patching instructions from the hunks as processed by the selected code generation agent, the patching instructions indicating an order in which to process the hunks when patching the existing computer code in the computer code generation session. Additionally, or alternatively, the process 1600 may include patching the existing computer code utilizing the hunks and based at least in part on the patching instructions. In some examples, patching the existing computer code utilizing the hunks comprises patching a first portion of the existing computer code utilizing the first hunks and/or patching a second portion of the existing computer code utilizing the second hunks after patching the first portion of the existing computer code.

In some examples, the trigger event is a first trigger event. Additionally, or alternatively, the process 1600 may include generating script representing a custom computer code generation agent based at least in part on the computer code generation session. Additionally, or alternatively, the process 1600 may include determining, based at least in part on attributes of the first trigger event, a second trigger event to associate with the custom computer code generation agent, the second trigger event being configured to initiate the script representing the custom computer code generation agent. Additionally, or alternatively, the process 1600 may include storing the custom computer code agent in a library of computer code generation agents associated with the user account.

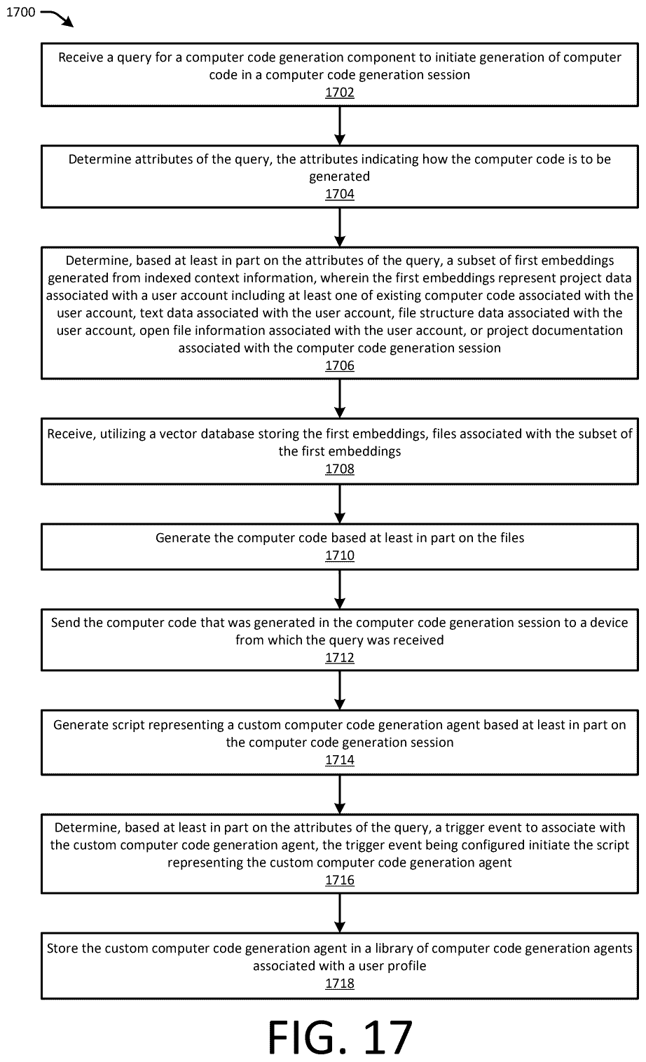

FIG. 17 illustrates a flow diagram of an example process 1700 for generating and storing a custom computer code generation agent. The process 1700 may create a customized agent script based on user interactions with a chat agent. Additionally, or alternatively, the process 1700 may be performed by one or more components and/or services offered by the code generation platform 102, as described with respect to FIGS. 1 and 2.

At 1702, the process 1700 may include receiving a query for a computer code generation component to initiate generation of computer code in a computer code generation session. In some examples, the computer code may be associated with elements of a GUI. Additionally, or alternatively, the query may be received from a user device 104 or triggered by an automated process within the code generation platform 102.

At 1704, the process 1700 may include determining attributes of the query, the attributes indicating how the computer code is to be generated.

At 1706, the process 1700 may include determining, based at least in part on the attributes of the query, a subset of first embeddings generated from indexed context information, wherein the first embeddings represent project data associated with a user account including at least one of existing computer code associated with the user account, text data associated with the user account, file structure data associated with the user account, open file information associated with the user account, or project documentation associated with the computer code generation session.

At 1708, the process 1700 may include receiving, utilizing a vector database storing the first embeddings, files associated with the subset of the first embeddings.

At 1710, the process 1700 may include generating the computer code based at least in part on the files.

At 1712, the process 1700 may include sending the computer code that was generated in the computer code generation session to a device from which the query was received.

At 1714, the process 1700 may include generating script representing a custom computer code generation agent based at least in part on the computer code generation session.

At 1716, the process 1700 may include determining, based at least in part on the attributes of the query, a trigger event to associate with the custom computer code generation agent, the trigger event being configured initiate the script representing the custom computer code generation agent.

At 1718, the process 1700 may include storing the custom computer code generation agent in a library of computer code generation agents associated with a user profile.

Additionally, or alternatively, the process 1700 may include determining that the trigger event has occurred. In some examples, the process 1700 may include selecting the custom computer code generation agent from the library of computer code generation agents based at least in part on determining that the trigger event has occurred. Additionally, or alternatively, the process 1700 may include executing the script representing the custom computer code generation agent.

Additionally, or alternatively, the process 1700 may include associating the custom computer code generation agent with metadata indicating attributes of the custom computer code generation agent. In some examples, the process 1700 may include receiving, from a different user account, a request for at least one already-generated custom computer code generation agent. Additionally, or alternatively, the process 1700 may include determining that the request is associated with the attributes. In some examples, the process 1700 may include enabling access to the custom computer code generation agent by the different user account based at least in part on the request being associated with the attributes of the custom computer code generation agent.

Additionally, or alternatively, the process 1700 may include receiving, from the user account, a request for an already-generated custom computer code generation agent as generated in association with a different user account. In some examples, the process 1700 may include determining one or more agent attributes identified in the request. Additionally, or alternatively, the process 1700 may include parsing a database of already-generated custom computer code generation agent utilizing the one or more agent attributes to identify the already-generated custom computer code generation agent. In some examples, the process 1700 may include enabling access to the already-generated custom computer code generation agent by the user account.

In some examples, the library may be a first library that is configured as a private library of computer code generation agents accessible by user accounts that are associated with a company associated with the user account. The first library may be different from a second library that is configured as a public library of computer code generation agents accessible by all user accounts.

Additionally, or alternatively, the library may be a first library that is configured as a public library of computer code generation agents accessible by all user accounts. In some examples, the process 1700 may include sending first data to a user device from which the query was received, the first data causing the device to display a graphical user interface (GUI) configured to receive user input indicating at least one of an approval or a rejection of the storing of the custom computer code generation agent in the first library. Additionally, or alternatively, the process 1700 may include receiving, via the GUI, second data representing the user input. In some examples, based at least in part on the user input, the process 1700 may include at least one of: storing the custom computer code generation agent in the first library; or refraining from storing the custom computer code generation agent in the first library.

In some examples, the files may be first files. Additionally, or alternatively, the process 1700 may include receiving, from the user account, data indicating that the custom computer code generation agent is to execute on second files associated with at least one of a folder, a file, or a type of file associated with the user account. In some examples, the process 1700 may include executing, based at least in part on the data, the script representing the custom computer code generation agent on individual ones of the second files. The script representing the custom computer code generation agent may be configured to execute on the individual ones of the second files sequentially and save results after each execution.

Additionally, or alternatively, the script representing the custom computer code generation agent may be executed on the second files at a first time. In some examples, the process 1700 may include storing a first hash representation of the second files at the first time. Additionally, or alternatively, the process 1700 may include determining a second hash representation of the second files at a second time that is after the first time. In some examples, the process 1700 may include determining that the second hash representation is different from the first hash representation. Additionally, or alternatively, based at least in part on determining that the second hash representation is different from the first hash representation, the process 1700 may include executing the script representing the custom computer code generation agent on the individual ones of the second files at the second time.

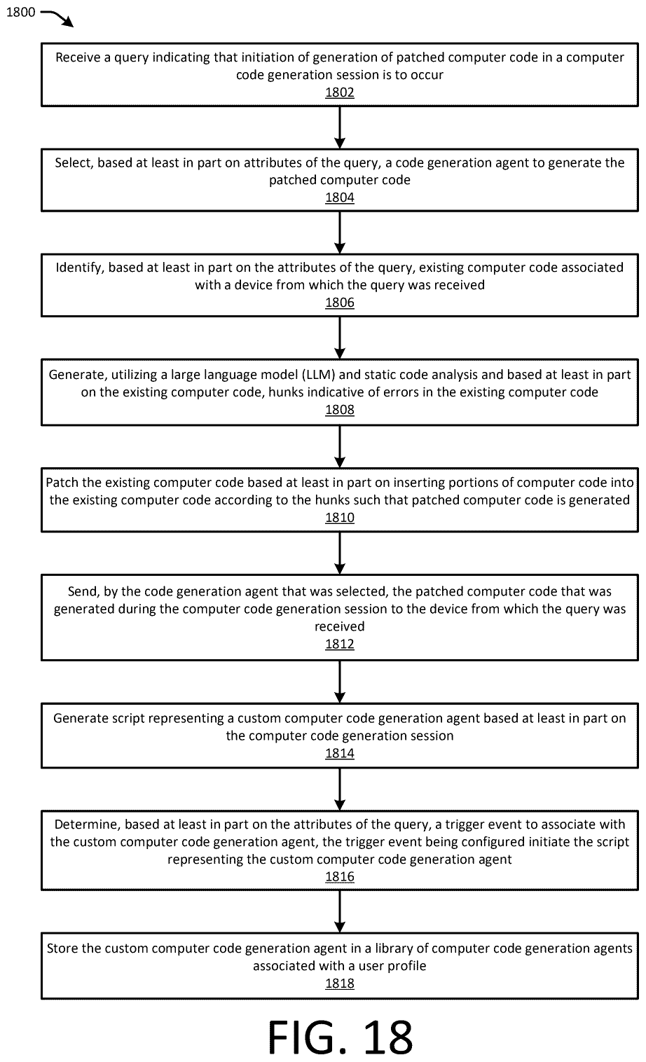

FIG. 18 illustrates a flow diagram of an example process 1800 for generating and storing a custom computer code generation agent. The process 1800 may guide a user through selections for agent type, trigger events, and actions to create a customized agent script. Additionally, or alternatively, the process 1800 may be performed by one or more components and/or services offered by the code generation platform 102, as described with respect to FIGS. 1 and 2.

At 1802, the process 1800 may include receiving a query indicating that initiation of generation of patched computer code in a computer code generation session is to occur.

At 1804, the process 1800 may include selecting, based at least in part on attributes of the query, a code generation agent to generate the patched computer code.

At 1806, the process 1800 may include identifying, based at least in part on the attributes of the query, existing computer code associated with a device from which the query was received.

At 1808, the process 1800 may include generating, utilizing a large language model (LLM) and static code analysis and based at least in part on the existing computer code, hunks indicative of errors in the existing computer code.

At 1810, the process 1800 may include patching the existing computer code based at least in part on inserting portions of computer code into the existing computer code according to the hunks such that patched computer code is generated.

At 1812, the process 1800 may include sending, by the code generation agent that was selected, the patched computer code that was generated during the computer code generation session to the device from which the query was received.

At 1814, the process 1800 may include generating script representing a custom computer code generation agent based at least in part on the computer code generation session.

At 1816, the process 1800 may include determining, based at least in part on the attributes of the query, a trigger event to associate with the custom computer code generation agent, the trigger event being configured initiate the script representing the custom computer code generation agent.

At 1818, the process 1800 may include storing the custom computer code generation agent in a library of computer code generation agents associated with a user profile.

Additionally, or alternatively, the process 1800 may include determining that the trigger event associated with the custom computer code generation agent has occurred. Additionally, or alternatively, the process 1800 may select the custom computer code generation agent from the library of computer code generation agents based at least in part on determining that the trigger event has occurred. Additionally, or alternatively, the process 1800 may execute the script representing the custom computer code generation agent.

Additionally, or alternatively, the process 1800 may include associating the custom computer code generation agent with metadata indicating attributes of the custom computer code generation agent. Additionally, or alternatively, the process 1800 may receive, from a different user profile, a request for at least one already-generated custom computer code generation agent. Additionally, or alternatively, the process 1800 may determine that the request is associated with the attributes and enable access to the custom computer code generation agent by the different user profile based at least in part on the request being associated with the attributes of the custom computer code generation agent.

Additionally, or alternatively, the process 1800 may include receiving, from the user profile, a request for an already-generated custom computer code generation agent as generated in association with a different user profile. Additionally, or alternatively, the process 1800 may determine one or more agent attributes identified in the request and parse a database of already-generated custom computer code generation agents utilizing the one or more agent attributes to identify the already-generated custom computer code generation agent. Additionally, or alternatively, the process 1800 may enable access to the already-generated custom computer code generation agent by the user profile.

Additionally, or alternatively, the process 1800 may include determining that the library is a first library that is configured as a private library of computer code generation agents accessible by user profiles that are associated with a company associated with the user profile, the first library being different from a second library that is configured as a public library of computer code generation agents accessible by all user profiles.

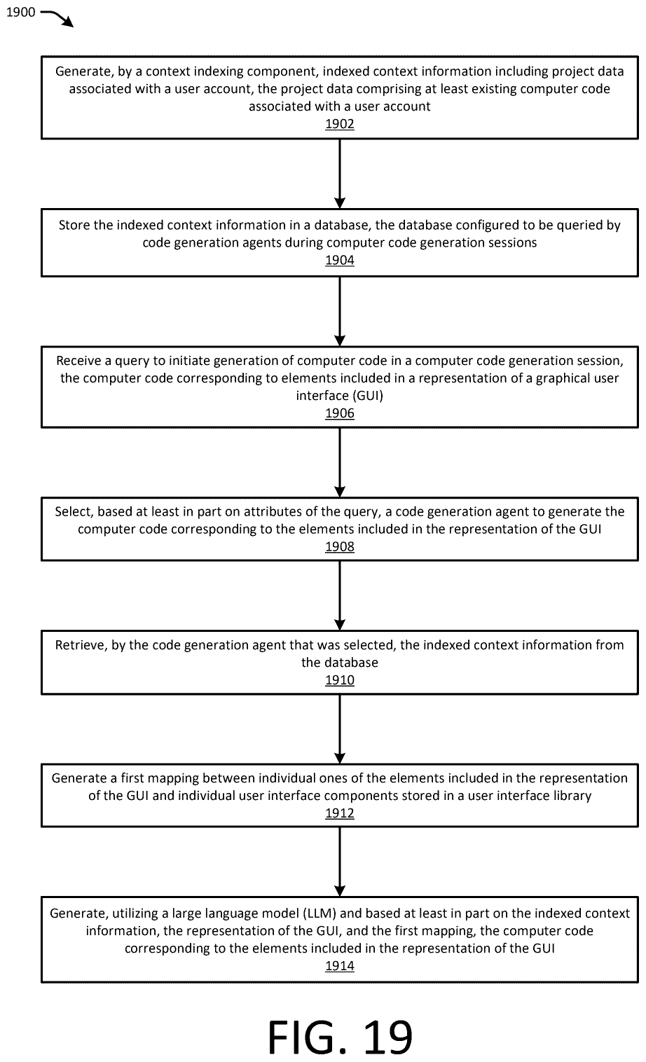

FIG. 19 illustrates a flow diagram of an example process 1900 for generating computer code using a graphical user interface (GUI) code generation agent. Additionally, or alternatively, the process 1900 may be performed by one or more components and/or services offered by the code generation platform 102, as described with respect to FIGS. 1 and 2. The process 1900 may focus on how the platform 102 selects the agent, retrieves and generates indexed context information, and utilizes this context to generate GUI-related code.

At 1902, the process 1900 may include generating, by a context indexing component, indexed context information including project data associated with a user account, the project data comprising at least existing computer code associated with a user account.

At 1904, the process 1900 may include storing the indexed context information in a database, the database configured to be queried by code generation agents during computer code generation sessions.

At 1906, the process 1900 may include receiving a query to initiate generation of computer code in a computer code generation session, the computer code corresponding to elements included in a representation of a graphical user interface (GUI).

At 1908, the process 1900 may include selecting, based at least in part on attributes of the query, a code generation agent to generate the computer code corresponding to the elements included in the representation of the GUI.

At 1910, the process 1900 may include retrieving, by the code generation agent that was selected, the indexed context information from the database.

At 1912, the process 1900 may include generating a first mapping between individual ones of the elements included in the representation of the GUI and individual user interface components stored in a user interface library.

At 1914, the process 1900 may include generating, utilizing a large language model (LLM) and based at least in part on the indexed context information, the representation of the GUI, and the first mapping, the computer code corresponding to the elements included in the representation of the GUI.

Additionally, or alternatively, the process 1900 may include determining, based at least in part on attributes of the query, properties associated with the representation of the GUI. In some examples, these properties may include a first property indicating at least a first element to be included in the GUI, a second property indicating an appearance of at least the first element of the GUI, a third property indicating functionality of at least the first element of the GUI, a fourth property indicating an organization of at least the first element of the GUI with respect to at least a second element of the GUI, a fifth property indicating an error associated with at least the first element of the GUI, and/or a sixth property indicating a design associated with the GUI. Additionally, or alternatively, the generation of the computer code may be further based at least in part on one or more of these properties associated with the GUI.

In some examples, the representation of the GUI may comprise at least one of a wireframe, a blueprint, a screenshot, an image, or a drawing.

Additionally, or alternatively, the process 1900 may include generating, by the context indexing component, additional contextual data. In some examples, the additional contextual data may indicate at least one of environmental data associated with the computer code generation session, a hierarchal summarization of a file structure of the files, and/or indexed external data. In some examples, the environmental data may comprise at least library information indicating one or more libraries installed on a user device associated with the user account, operating system information indicating details of an operating system utilized by the user account, and/or database information indicating details of one or more databases utilized by the user account. Additionally, or alternatively, the hierarchal summarization may be based at least in part on the file structure data, with the file structure indicating associations between the files in the file structure and a hierarchy of the files in the file structure. Additionally, or alternatively, the indexed external data may include at least plugin documentation, external documents that are not specific to the user account, languages and frameworks specifications, security vulnerability database information, and related public documents. Additionally, or alternatively, the process 1900 may include storing this additional contextual data in the database, and/or generating the computer code may be further based at least in part on this additional contextual data.

Additionally, or alternatively, the process 1900 may include generating script representing a custom computer code generation agent based at least in part on the computer code generation session. The process 1900 may include determining, based at least in part on attributes of the query, a trigger event to associate with the custom computer code generation agent, the trigger event being configured to initiate the script representing the custom computer code generation agent. The process 1900 may include storing the custom computer code agent in a library of computer code generation agents associated with the user account.

Additionally, or alternatively, the query may be a first query, and the process 1900 may include generating, based at least in part on attributes of the query, a prompt configured to be input into the LLM, the prompt comprising information associated with the project data and a second query for information to facilitate generation of a response to the first query. The process 1900 may include receiving, from the LLM and based at least in part on inputting the prompt input the LLM, output data representing the information to facilitate the generation of the response to the first query. In some examples, retrieving the indexed context information from the database may be based at least in part on the information indicating the indexed context information from additional indexed context information.

The process 1900 provides a comprehensive approach to generating GUI-related code by leveraging contextual information, code generation agents, and large language models. This approach may enable more efficient and accurate development of graphical user interfaces within software applications.

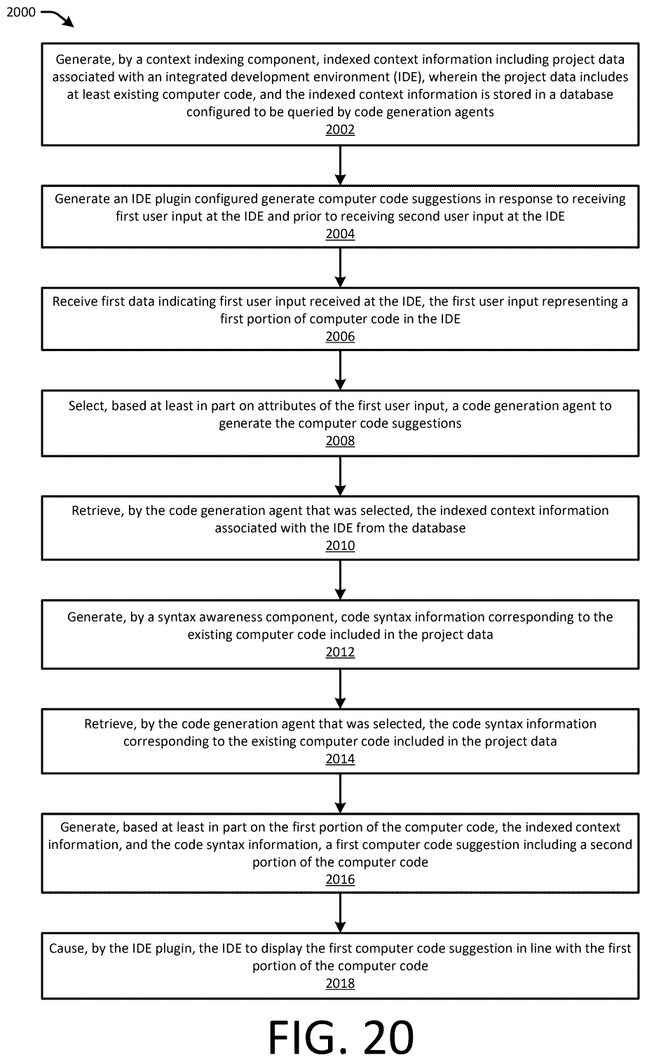

FIG. 20 illustrates a flow diagram of an example process 2000 for generating and presenting computer code suggestions in an integrated development environment (IDE). The process 2000 may leverage context and syntax information to provide relevant code suggestions in line with user input. In some examples, the process 2000 may be performed by one or more components and/or services offered by the code generation platform 102, as described with respect to FIGS. 1 and 2.

At 2002, the process 2000 may include generating, by a context indexing component, indexed context information including project data associated with an integrated development environment (IDE), wherein the project data includes at least existing computer code, and the indexed context information is stored in a database configured to be queried by code generation agents.

At 2004, the process 2000 may include generating an IDE plugin configured generate computer code suggestions in response to receiving first user input at the IDE and prior to receiving second user input at the IDE.

At 2006, the process 2000 may include receiving first data indicating first user input received at the IDE, the first user input representing a first portion of computer code in the IDE.

At 2008, the process 2000 may include selecting, based at least in part on attributes of the first user input, a code generation agent to generate the computer code suggestions.

At 2010, the process 2000 may include retrieving, by the code generation agent that was selected, the indexed context information associated with the IDE from the database.

At 2012, the process 2000 may include generating, by a syntax awareness component, code syntax information corresponding to the existing computer code included in the project data.

At 2014, the process 2000 may include retrieving, by the code generation agent that was selected, the code syntax information corresponding to the existing computer code included in the project data.

At 2016, the process 2000 may include generating, based at least in part on the first portion of the computer code, the indexed context information, and the code syntax information, a first computer code suggestion including a second portion of the computer code.

At 2018, the process 2000 may include causing, by the IDE plugin, the IDE to display the first computer code suggestion in line with the first portion of the computer code.

Additionally, or alternatively, the process 2000 may include generating, by the context indexing component, synthetic information associated with the project data, wherein the synthetic information is based at least in part on information extracted from the existing computer code and is stored in the database. Additionally, or alternatively, the process 2000 may include retrieving, by the code generation agent, the synthetic information associated with the project data. In some examples, generating the first computer code suggestion is further based at least in part on the synthetic information.

Additionally, or alternatively, the process 2000 may include generating an abstract syntax tree (AST) representing the computer code included in the IDE. In some examples, the process 2000 may include generating the code syntax information based at least in part on traversing the AST to extract the code syntax information. This approach may enable a deeper understanding of the code structure and relationships between code elements.

In some examples, the computer code suggestion comprises at least one of a computer code snippet, function, class, and/or variable name.

In some examples, the trigger event may be a first trigger event. Additionally, or alternatively, the process 2000 may include receiving second data indicating that a second trigger event has occurred, the second trigger event indicative of the additional user input received in association with the IDE, the additional user input representing computer code. Additionally, or alternatively, the process 2000 may include generating, based at least in part on the user input, the additional user input, and the context indexing component processing the project data, an additional computer code suggestion. Additionally, or alternatively, the process 2000 may include causing the IDE to display the additional computer code suggestion in line with the additional user input subsequent to receiving the additional user input.

In some examples, the trigger event may be a first trigger event. Additionally, or alternatively, the process 2000 may include receiving second data indicating that a second trigger event has occurred, the second trigger event indicative of the additional user input received in association with the IDE, the additional user input representing an acceptance of the computer code suggestion. Additionally, or alternatively, the process 2000 may include generating, based at least in part on the user input, the additional user input, and the context indexing component processing the project data, an additional computer code suggestion. Additionally, or alternatively, the process 2000 may include causing the IDE to display the additional computer code suggestion in line with the computer code suggestion subsequent to receiving the additional user input.

In some examples, the trigger event may be a first trigger event. Additionally, or alternatively, the process 2000 may include receiving second data indicating that a second trigger event has occurred, the second trigger event indicative of the additional user input received in association with the IDE, the additional user input representing a rejection of the computer code suggestion. Additionally, or alternatively, the process 2000 may include generating, based at least in part on the user input, the additional user input, and the context indexing component processing the project data, an additional computer code suggestion. Additionally, or alternatively, the process 2000 may include causing the IDE to display the additional computer code suggestion in line with the user input subsequent to receiving the additional user input.

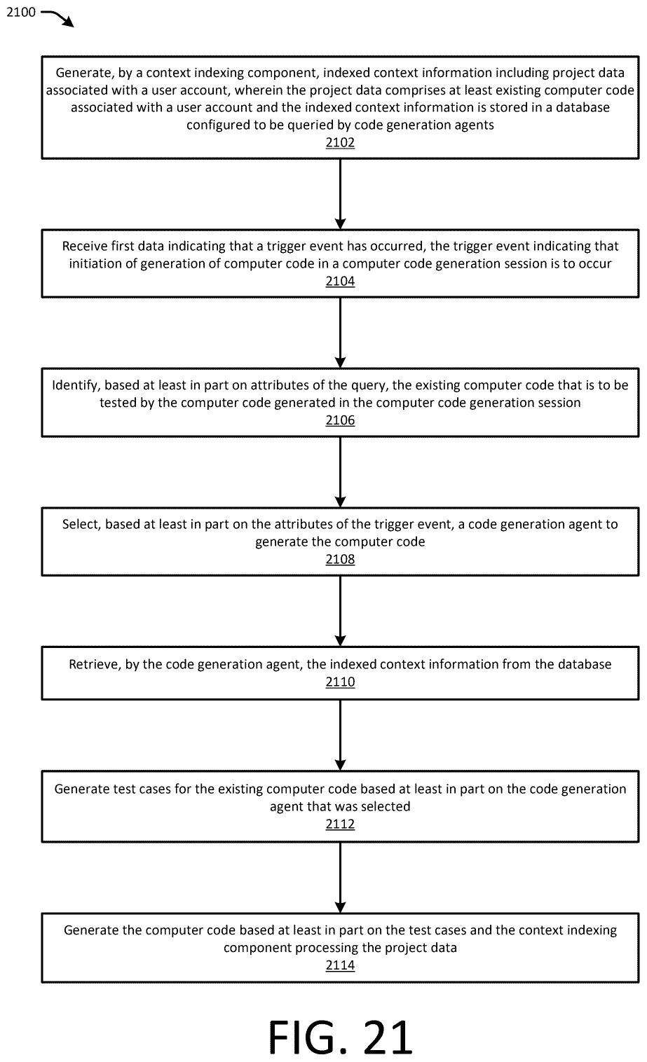

FIG. 21 illustrates a flow diagram of an example process 2100 for generating unit test computer code configured to test existing computer code. The process 2100 may involve generating various types of test cases, executing those test cases against the existing code, and/or potentially refactoring or patching the existing code based on the test results. In some examples, the process 2100 may be performed by one or more components and/or services offered by the code generation platform 102, as described with respect to FIGS. 1 and 2.

At 2102, the process 2100 may include generating, by a context indexing component, indexed context information including project data associated with a user account, wherein the project data comprises at least existing computer code associated with a user account and the indexed context information is stored in a database configured to be queried by code generation agents.

At 2104, the process 2100 may include receiving first data indicating that a trigger event has occurred, the trigger event indicating that initiation of generation of computer code in a computer code generation session is to occur.

At 2106, the process 2100 may include identifying, based at least in part on attributes of the query, the existing computer code that is to be tested by the computer code generated in the computer code generation session.

At 2108, the process 2100 may include selecting, based at least in part on the attributes of the trigger event, a code generation agent to generate the computer code.

At 2110, the process 2100 may include retrieving, by the code generation agent, the indexed context information from the database.

At 2112, the process 2100 may include generating test cases for the existing computer code based at least in part on the code generation agent that was selected.

At 2114, the process 2100 may include generating the computer code based at least in part on the test cases and the context indexing component processing the project data.

Additionally, or alternatively, the process 2100 may include generating test results based at least in part on executing the computer code to test the existing computer code. Additionally, or alternatively, the process 2100 may include sending data representing the test results to a device associated with the trigger event, the data causing the device to display the test results.

Additionally, or alternatively, the process 2100 may include requesting, by the code generation agent, a refactoring component to provide an assessment of the existing computer code regarding testability. Additionally, or alternatively, the process 2100 may include determining, based at least in part on the assessment, that the existing computer code is below a threshold testability. Additionally, or alternatively, the process 2100 may include refactoring the existing computer code such that refactored existing computer code is generated. Additionally, or alternatively, the process 2100 may include generating the test cases for the refactored existing computer code.

In some examples, the code generation agent that was selected is from multiple code generation agents configured to generate the computer code for a given purpose, the given purpose including at least one of performing behavioral tests on the existing computer code and/or performing code-based tests on the existing computer code.

In some examples, the behavioral tests are determined based at least in part on at least one of: method signatures in the existing code, comments associated with the existing code, and/or documentation associated with the existing code. Additionally, or alternatively, the code-based tests are determined based at least in part on at least one of: a body of code within a method of the existing code, logic within the existing code, and/or code paths within the existing code.

Additionally, or alternatively, the process 2100 may generating the test cases for the existing computer code utilizing a large language model (LLM). Additionally, or alternatively, the process 2100 may include sending second data representing the test cases to a device associated with the trigger event, the second data causing the device to display the test cases and receive user input associated with the test cases. Additionally, or alternatively, the process 2100 may include receiving third data representing the user input from the device, the user input indicating at least one of an acceptance of the test cases, a rejection of the test cases, or a modification associated with the test cases. Additionally, or alternatively, the process 2100 may include generating the computer code further based at least in part on the third data.

Additionally, or alternatively, the process 2100 may include generating diagnostics data indicative of errors in the computer code based at least in part on a large language model (LLM) processing the existing computer code and the computer code. Additionally, or alternatively, the process 2100 may include generating, utilizing the LLM, hunks indicative of the errors in the computer code, wherein the errors are organized within the hunks based at least in part on types of the errors indicated by the diagnostics data. Additionally, or alternatively, the process 2100 may include patching the computer code utilizing the hunks such that patched computer code is generated. Additionally, or alternatively, the process 2100 may include sending second data representing the patched computer code to a device associated with the trigger event, the second data causing the device to display the patched computer code and receive user input associated with the patched computer code. Additionally, or alternatively, the process 2100 may include receiving third data representing the user input from the device, the user input indicating at least one of an acceptance of the patched computer code, a rejection of the patched computer code, or a modification associated with the patched computer code. Additionally, or alternatively, the process 2100 may include sending a response to the device based at least in part on the third data.

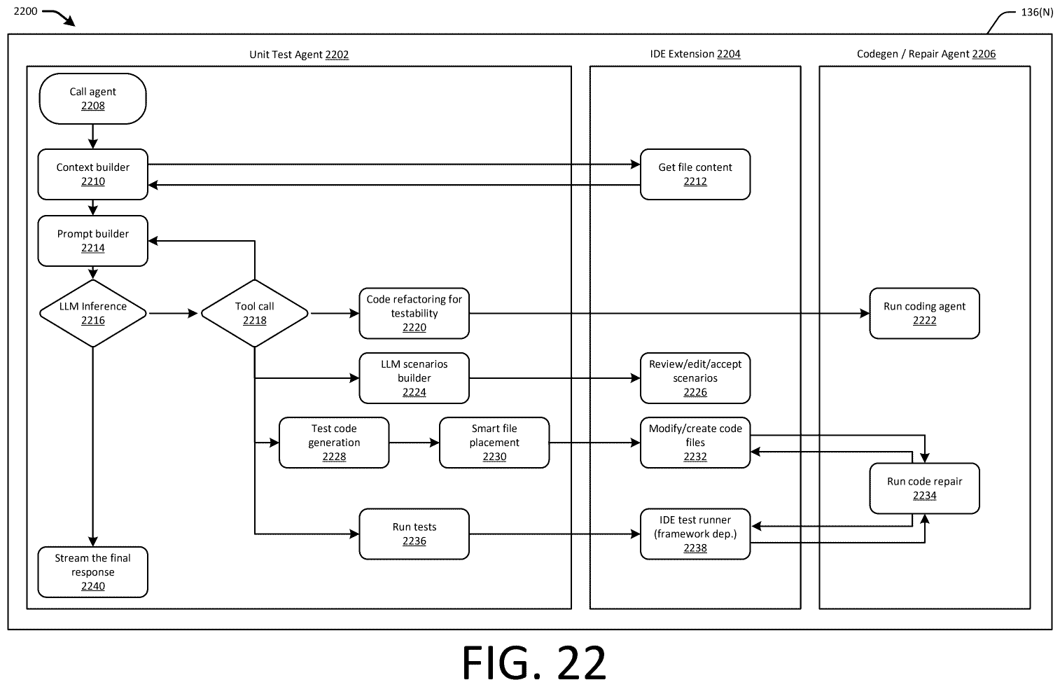

FIG. 22 illustrates a flow diagram of an example process 2200 performed at least partly by a unit testing agent tool 136(N) for generating unit test computer code configured to test existing computer code. The process 2200 may be carried out at least partly by a unit test agent 2202, an IDE extension 2204, and/or a codegen/repair agent 2206.

At 2208, the process 2200 may begin when an agent is called. This may correspond to receiving a query or trigger event to initiate generation of computer code for testing existing code. At 2210, the process 2200 may leverage a context builder, which, at 2212, may interact with the IDE extension 2204 to get file content(s). In some examples, this may involve requesting and generating indexed context information associated with the code generation session.

After context building, the process 2200 may proceed to prompt building at 2214. In some examples, building a prompt may involve using the context information gathered to formulate specific prompts or queries, in a particular format, for input into an LLM. For example, the prompt may be constructed to request generation of test cases based on the existing code and context, in a format that is understandable by the LLM. That is, the prompt builder may modify the format of the data such that it may be input into the LLM while the information carried by the data remains unchanged. The prompt may include details about the code structure, function signatures, and/or any relevant documentation or comments. In some examples, building a prompt in this way may help focus the LLM on generating relevant and appropriate test cases for the given code. Additionally, or alternatively the prompt may incorporate any specific testing requirements or guidelines that were identified during the context building phase. By carefully constructing the prompt, the system may improve the quality and relevance of the generated test cases.

Once the prompt is built, at 2216 the process 2200 may include inferencing the LLM based on the prompt, which may branch into multiple paths depending on a required tool that is called. For example, at 2218, required tools may be called. Tools may be called to execute in sequential order, allowing a user to review, edit, and/or accept the output produced by a given tool before executing the next tool in the sequence. Additionally, or alternatively, tools may be called to execute in parallel. In some examples, a tool that can be called at 2218 may be to refactor the existing computer code for testability. That is, at 2220, the process 2200 may include refactoring the code for testability. In some examples, the system may assess the existing code's testability and may determine to refactor the code if it is below a threshold testability (or below an industry standard). At 2222, a coding agent may be leveraged to refactor the code into a more testable format. The refactored code may then be presented to the user (e.g., on the IDE) allowing a user to review, edit, and/or accept the refactored code.

Additionally, or alternatively, another tool that may be called at 2218 includes an LLM scenarios builder at 2224. That is, an LLM may generate test scenarios, which at 2226 may be presented to a user for reviewing, editing, and accepting the scenarios. This may involve generating test cases for the existing code, potentially using behavioral tests based on method signatures, comments, or documentation, and code-based tests examining the body of code, logic, or code paths.

Additionally, or alternatively, another tool may be called at 2228 for test code generation based on the test scenarios. At 2230, the process 2200 may include smart file placement. In some examples, smart file placement may involve analyzing the existing project structure and determining the most appropriate location to place newly generated test files. For example, the system may examine the current file organization, naming conventions, and test directory structure to intelligently place new test files in a manner consistent with the project's existing patterns. This smart placement may help maintain code organization and make it easier for developers to locate and manage test files. Additionally, the system may consider factors such as test framework preferences, module dependencies, and file proximity to the code being tested when determining optimal file placement. In some examples, the smart file placement process 2230 may produce an output indicating the location for newly generated files, allowing the user to review, edit, and/or accept the output.

At 2232, the process 2200 may include modifying/creating code files. This may represent generating the actual test code based on the test cases and context information. In some examples, the test code may be presented to the user allowing the user to review, edit, and/or accept the test code. At 2234, the process 2200 may include running a coding repair agent on the test code that was generated to correct any potential bugs. That is, at 2234, the process 2200 may involve generating feedback data from test execution, using an LLM to generate hunks indicating changes to be made, and patching the generated test code accordingly. The results of the coding repair agent may also be presented to the user allowing the user to review, edit, and/or accept the changes to be made to the test code. At 2236, the process may include running the tests within the generated test code. This may be achieved at 2238, where an IDE test runner is leveraged to execute the tests. In some examples, the results from executing the tests within the generated test code may be presented to the user allowing the user to review the results of the tests and/or request additional code repair. Additionally, or alternatively, following execution of the tests at 2238, the process 2200 may include again running a coding repair agent on the test code that was generated to correct any potential bugs that may be discovered during execution of the test code. That is, at 2234, the process 2200 may involve generating feedback data from test execution, using an LLM to generate hunks indicating changes to be made, and patching the generated test code accordingly. In some examples, the results of the coding repair agent may again be presented to the user allowing the user to review, edit, and/or accept the changes to be made to the test code.

At 2240, the process 2200 may conclude by streaming the final response to the user device that requested the test code. That is, the test results, test code, and/or any other additional feedback may be sent to the user device for display. Additionally, or alternatively, step 2240 may represent the output produced by a given tool and may be performed following execution of a tool, allowing the user to review, edit, and/or accept the output produced by the given tool before proceeding to execute another tool.

Throughout the process, the unit test agent 2202, IDE extension 2204, and codegen/repair agent 2206 may interact to perform various operations for code generation, testing, and repair, potentially utilizing LLMs and context information to enhance the testing and code improvement process, as described herein.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
non-transitory computer-readable media storing computer-executable instructions that, when executed by the one or more processors, cause the system to perform operations comprising:
generating, by a context indexing component, indexed context information including project data comprising at least existing computer code associated with a user account;
storing the indexed context information in a database, the database configured to be queried by code generation agents during computer code generation sessions;
receiving a query for a computer code generation component of the system to initiate generation of patched computer code in a computer code generation session;
selecting, based at least in part on attributes of the query, a code generation agent to generate the patched computer code;
retrieving, by the code generation agent that was selected, the indexed context information from the database;
generating, utilizing a large language model (LLM) and static code analysis and based at least in part on the existing computer code, hunks indicative of errors in the existing computer code;
patching the existing computer code based at least in part on inserting portions of computer code into the existing computer code according to the hunks such that the patched computer code is generated; and
sending, by the code generation agent that was selected, the patched computer code that was generated to a device from which the query was received.

2. The system of claim 1, the operations further comprising:
generating, based at least in part on the static code analysis, diagnostics data indicative of the errors in the existing computer code based at least in part on a diagnostics component of the system processing the existing computer code;
filtering, utilizing the diagnostics component, the errors indicated by the diagnostics data such that filtered diagnostics data is generated, the filtered diagnostics data indicating types of the errors in the existing computer code; and
wherein the errors are organized within the hunks based at least in part on the types of the errors indicated by the filtered diagnostics data.

3. The system of claim 2, wherein the types of the errors include at least one of:
syntax errors;
compilation errors;
runtime errors;
logical errors;
resource errors;
arithmetic errors;
semantic errors; or
interface errors.

4. The system of claim 1, the operations further comprising, prior to generating the patched computer code:
generating first data representative of changes in the patched computer code with respect to the existing computer code; and
sending the first data to a device from which the query was received, the first data causing an integrated development environment (IDE) extension to display the changes in the patched computer code on the device.

5. The system of claim 4, the operations further comprising, prior to generating the patched computer code:
receiving, responsive to the first data and from the device, second data representing at least one of an acceptance, a rejection, or a modification associated with the changes in the patched computer code; and
based at least in part on the second data, at least one of:
patching the existing computer code to generate the patched computer code based at least in part on the acceptance;
patching the existing computer code to generate the patched computer code based at least in part on the modification; or
refraining from generating the patched computer code.

6. The system of claim 1, wherein the hunks include first hunks and second hunks, and the operations further comprising:
generating patching instructions from the hunks as processed by the selected code generation agent, the patching instructions indicating an order in which to process the hunks when patching the existing computer code in the computer code generation session; and
patching the existing computer code utilizing the hunks and based at least in part on the patching instructions, wherein patching the existing computer code utilizing the hunks comprises:
patching a first portion of the existing computer code utilizing the first hunks; and
patching a second portion of the existing computer code utilizing the second hunks after patching the first portion of the existing computer code.

7. The system of claim 1, the operations further comprising:
generating first data representing a toggle element of an integrated development environment (IDE) associated with the user account, the toggle being configured with:
a first toggle position enabling execution of the generation of the patched computer code without receiving user input indicating approval of the patching of the existing computer code; and
a second toggle position preventing execution of the generation of the patched computer code without receiving the user input indicating the approval of the patching of the existing computer code.

8. A method comprising:
generating, by a context indexing component, indexed context information including project data comprising at least existing computer code associated with a user account;
storing the indexed context information in a database, the database configured to be queried by code generation agents during computer code generation sessions;
receiving a query for a computer code generation component of the system to initiate generation of patched computer code in a computer code generation session;
selecting, based at least in part on attributes of the query, a code generation agent to generate the patched computer code;
retrieving, by the code generation agent that was selected, the indexed context information from the database;
generating, utilizing a large language model (LLM) and static code analysis and based at least in part on the existing computer code, hunks indicative of errors in the existing computer code;
patching the existing computer code based at least in part on inserting portions of computer code into the existing computer code according to the hunks such that the patched computer code is generated; and
sending, by the code generation agent that was selected, the patched computer code that was generated to a device from which the query was received.

9. The method of claim 8, further comprising:
generating, based at least in part on the static code analysis, diagnostics data indicative of the errors in the existing computer code based at least in part on a diagnostics component of the system processing the existing computer code;
filtering, utilizing the diagnostics component, the errors indicated by the diagnostics data such that filtered diagnostics data is generated, the filtered diagnostics data indicating types of the errors in the existing computer code; and
wherein the errors are organized within the hunks based at least in part on the types of the errors indicated by the filtered diagnostics data.

10. The method of claim 9, wherein the types of errors include at least one of:
syntax errors;
compilation errors;
runtime errors;
logical errors;
resource errors;
arithmetic errors;
semantic errors; or
interface errors.

11. The method of claim 8, further comprising, prior to generating the patched computer code:
generating first data representative of changes in the patched computer code with respect to the existing computer code; and
sending the first data to a device from which the query was received, the first data causing an integrated development environment (IDE) extension to display the changes in the patched computer code on the device.

12. The method of claim 11, further comprising, prior to generating the patched computer code:
receiving, responsive to the first data and from the device, second data representing at least one of an acceptance, a rejection, or a modification associated with the changes in the patched computer code; and
based at least in part on the second data, at least one of:
patching the existing computer code to generate the patched computer code based at least in part on the acceptance;
patching the existing computer code to generate the patched computer code based at least in part on the modification; or
refraining from generating the patched computer code.

13. The method of claim 8, wherein the hunks include first hunks and second hunks, and the method further comprising:
generating patching instructions from the hunks as processed by the selected code generation agent, the patching instructions indicating an order in which to process the hunks when patching the existing computer code in the computer code generation session; and
patching the existing computer code utilizing the hunks and based at least in part on the patching instructions, wherein patching the existing computer code utilizing the hunks comprises:
patching a first portion of the existing computer code utilizing the first hunks; and
patching a second portion of the existing computer code utilizing the second hunks after patching the first portion of the existing computer code.

14. The method of claim 8, further comprising:
generating first data representing a toggle element of an integrated development environment (IDE) associated with the user account, the toggle being configured with:
a first toggle position enabling execution of the generation of the patched computer code without receiving user input indicating approval of the patching of the existing computer code; and
a second toggle position preventing execution of the generation of the patched computer code without receiving the user input indicating the approval of the patching of the existing computer code.

15. One or more non-transitory computer-readable media storing instructions that, when executed by one or more processors, cause the processors to perform operations comprising:
generating, by a context indexing component, indexed context information including project data comprising at least existing computer code associated with a user account;
storing the indexed context information in a database, the database configured to be queried by code generation agents during computer code generation sessions;
receiving a query for a computer code generation component of the system to initiate generation of patched computer code in a computer code generation session;
selecting, based at least in part on attributes of the query, a code generation agent to generate the patched computer code;
retrieving, by the code generation agent that was selected, the indexed context information from the database;
generating, utilizing a large language model (LLM) and static code analysis and based at least in part on the existing computer code, hunks indicative of errors in the existing computer code;
patching the existing computer code based at least in part on inserting portions of computer code into the existing computer code according to the hunks such that the patched computer code is generated; and
sending, by the code generation agent that was selected, the patched computer code that was generated to a device from which the query was received.

16. The one or more non-transitory computer-readable media of claim 15, the operations further comprising:
generating, based at least in part on the static code analysis, diagnostics data indicative of the errors in the existing computer code based at least in part on a diagnostics component of the system processing the existing computer code;
filtering, utilizing the diagnostics component, the errors indicated by the diagnostics data such that filtered diagnostics data is generated, the filtered diagnostics data indicating types of the errors in the existing computer code; and
wherein the errors are organized within the hunks based at least in part on the types of the errors indicated by the filtered diagnostics data.

17. The one or more non-transitory computer-readable media of claim 16, wherein the types of the errors include at least one of:
syntax errors;
compilation errors;
runtime errors;
logical errors;
resource errors;
arithmetic errors;
semantic errors; or
interface errors.

18. The one or more non-transitory computer-readable media of claim 13, the operations further comprising, prior to generating the patched computer code:
generating first data representative of changes in the patched computer code with respect to the existing computer code; and
sending the first data to a device from which the query was received, the first data causing an integrated development environment (IDE) extension to display the changes in the patched computer code on the device.

19. The one or more non-transitory computer-readable media of claim 18, the operations further comprising, prior to generating the patched computer code:
receiving, responsive to the first data and from the device, second data representing at least one of an acceptance, a rejection, or a modification associated with the changes in the patched computer code; and
based at least in part on the second data, at least one of:
patching the existing computer code to generate the patched computer code based at least in part on the acceptance;
patching the existing computer code to generate the patched computer code based at least in part on the modification; or
refraining from generating the patched computer code.

20. The one or more non-transitory computer-readable media of claim 15, wherein the hunks include first hunks and second hunks, and the operations further comprising:
generating patching instructions from the hunks as processed by the selected code generation agent, the patching instructions indicating an order in which to process the hunks when patching the existing computer code in the computer code generation session; and
patching the existing computer code utilizing the hunks and based at least in part on the patching instructions, wherein patching the existing computer code utilizing the hunks comprises:
patching a first portion of the existing computer code utilizing the first hunks; and
patching a second portion of the existing computer code utilizing the second hunks after patching the first portion of the existing computer code.
